(19) United States
(12) Patent Application Publication
(10) Pub. No.: US 2022/0115705 A1
(43) Pub. Date: Apr. 14, 2022

(54) ELECTROCHEMICAL CELLS COMPRISING NITROGEN-CONTAINING SPECIES, AND METHODS OF FORMING THEM

(71) Applicant: Sion Power Corporation, Tucson, AZ (US)

(72) Inventors: Igor P. Kovalev, Vail, AZ (US); Yuriy V. Mikhaylik, Tucson, AZ (US)

(73) Assignee: Sion Power Corporation, Tucson, AZ (US)

(21) Appl. No.: 17/492,084

(22) Filed: Oct. 1, 2021

Related U.S. Application Data
(60) Provisional application No. 63/090,146, filed on Oct. 9, 2020.

(51) Int. Cl. H01M 10/0569; H01M 10/052; H01M 4/38; H01M 4/36; H01M 4/04; H01M 10/0568

(52) U.S. Cl. CPC H01M 10/0569; H01M 10/052; H01M 4/382; H01M 2300/0028; H01M 4/0419; H01M 10/0568; H01M 4/0407; H01M 4/366

(57) ABSTRACT

Articles and methods related to electrochemical cells and/or electrochemical cell components comprising species comprising a conjugated, negatively-charged ring comprising a nitrogen atom and/or reaction products of such species are generally provided. The electrochemical cell may comprise an electrolyte comprising a species comprising a conjugated, negatively-charged ring comprising a nitrogen atom, which may further comprise a species comprising a labile halogen atom. In some embodiments, the electrochemical cell comprises an electrode comprising lithium metal. In some embodiments, the electrochemical cell comprises a protective layer comprising a species comprising a conjugated, negatively-charged ring comprising a nitrogen atom and/or a reaction product thereof.

### RELATED APPLICATIONS

This application claims priority under 35 U.S.C. § 119(e) to U.S. Provisional Patent Application No. 63/090,146, filed Oct. 9, 2020, which are hereby incorporated by reference in their entireties.

### FIELD

Articles and methods involving electrochemical cells and/or electrochemical cell components comprising species comprising a conjugated, negatively-charged ring comprising a nitrogen atom and/or reaction products of such species are generally provided.

### BACKGROUND

There has been considerable interest in recent years in developing high energy density batteries with lithium-containing anodes. In such cells, anodes and cathodes may undergo reactions with electrolyte components that result in the formation of undesirable species. Rechargeable batteries in which these undesirable species form generally exhibit limited cycle lifetimes. Accordingly, articles and methods for increasing the cycle lifetime and/or other improvements would be beneficial.

### SUMMARY

Articles and methods related to electrochemical cells and/or electrochemical cell components comprising species comprising a conjugated, negatively-charged ring comprising a nitrogen atom and/or reaction products of such species are generally provided. The subject matter disclosed herein involves, in some cases, interrelated products, alternative solutions to a particular problem, and/or a plurality of different uses of one or more systems and/or articles.

Certain embodiments are related to electrochemical cells. In some embodiments, the electrochemical cell comprises a first electrode comprising lithium metal; and an electrolyte, wherein the electrolyte comprises a species comprising a conjugated, negatively-charged ring comprising a nitrogen atom. In some embodiments, the electrolyte further comprises a second species comprising a labile halogen atom. In some embodiments, an electron-withdrawing substituent is absent from the species comprising a conjugated, negatively-charged ring comprising a nitrogen atom.

In some embodiments, the electrochemical cell comprises a first electrode comprising lithium metal; and a protective layer disposed on the first electrode, wherein the protective layer comprises a species comprising a conjugated, negatively-charged ring comprising a nitrogen atom and/or a reaction product thereof. In some embodiments, an electron-withdrawing substituent is absent from the species.

Certain embodiments are related to methods. In some embodiments, the method comprises placing a volume of an electrolyte in an electrochemical cell comprising a first electrode, wherein the first electrode comprises lithium metal, and wherein the electrolyte comprises a species comprising a conjugated, negatively-charged ring comprising a nitrogen atom; and forming a protective layer on the first electrode, wherein the protective layer comprises the species and/or a reaction product thereof. In some embodiments, an electron-withdrawing substituent is absent from the species comprising a conjugated, negatively-charged ring comprising a nitrogen atom.

In some embodiments, the reaction product comprises a reaction product between the lithium metal and the species comprising a conjugated, negatively-charged ring comprising a nitrogen atom. In some embodiments, the reaction product comprises a reaction product between the species comprising a conjugated, negatively-charged ring comprising a nitrogen atom and a second species comprising a labile halogen atom. In some embodiments, the reaction product comprises a reaction product between the species comprising a conjugated, negatively-charged ring comprising a nitrogen atom, the second species comprising a labile halogen atom, and the lithium metal.

In some embodiments, the electrochemical cell comprises a second electrode. In some embodiments, the second electrode comprises a transition metal. In some embodiments, a second protective layer is disposed on the second electrode. In some embodiments, the second protective layer comprises the species comprising a conjugated, negatively-charged ring comprising a nitrogen atom and/or a second reaction product thereof. In some embodiments, the second reaction product comprises a reaction product between the transition metal and the species comprising a conjugated, negatively-charged ring comprising a nitrogen atom. In some embodiments, the reaction product comprises a reaction product between the species comprising a conjugated, negatively-charged ring comprising a nitrogen atom and a second species comprising a labile halogen atom. In some embodiments, the reaction product comprises a reaction product between the species comprising a conjugated, negatively-charged ring comprising a nitrogen atom, the second species comprising a labile halogen atom, and the transition metal.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, in accordance with some embodiments, an electrochemical cell comprising a first electrode and an electrolyte comprising a first reactive species (i.e., a species comprising a conjugated, negatively-charged ring comprising a nitrogen atom).

FIG. 1B shows, in accordance with some embodiments, an electrochemical cell comprising a first electrode and a layer (e.g., a protective layer).

FIG. 1C shows, in accordance with some embodiments, an electrochemical cell comprising a first electrode, a second electrode, and an electrolyte.

FIG. 1D shows, in accordance with some embodiments, an electrochemical cell comprising a first electrode, a second electrode, and an electrolyte, wherein the electrolyte comprises a first reactive species (i.e., a species comprising a conjugated, negatively-charged ring comprising a nitrogen atom) and a second reactive species (e.g., a species comprising a labile halogen atom).

FIG. 1E shows, in accordance with some embodiments, an electrochemical cell comprising a first electrode, a second electrode, an electrolyte (wherein the electrolyte comprises a first reactive species (i.e., a species comprising a conjugated, negatively-charged ring comprising a nitrogen atom) and a second reactive species (e.g., a species comprising a labile halogen atom)), and a layer (e.g., wherein the layer comprises a reaction product between the first reactive species and the second reactive species).

FIG. 1F shows, in accordance with some embodiments, an electrochemical cell comprising a first electrode, a second electrode, an electrolyte, and a layer (e.g., a protective layer), wherein the layer comprises a reaction product (e.g., a reaction product of the first reactive species and the second reactive species; a reaction product between the first reactive species and a metal of one of the electrodes; and/or a reaction product between the first reactive species, the second reactive species, and a metal of one of the electrodes).

FIG. 1G shows, in accordance with some embodiments, an electrochemical cell comprising a first electrode, a second electrode, an electrolyte, and a layer (e.g., a protective layer), wherein the layer comprises a reaction product between a transition metal (e.g., in the second electrode) and the first reactive species.

FIG. 2 shows, in accordance with some embodiments, an electrochemical cell to which an anisotropic force is applied.

FIG. 3 shows, in accordance with some embodiments, discharge capacity (mAh) as a function of cycle for Example 1 and Comparative Example 1.

FIG. 4 shows, in accordance with some embodiments, discharge capacity (mAh) as a function of cycle for Example 2 and Comparative Examples.

### DETAILED DESCRIPTION

Articles and methods related to electrochemical cells including a species comprising a conjugated, negatively-charged ring including a nitrogen atom, and reaction products of such species, are generally provided. As described in further detail below, such species may be referred to throughout as “first reactive species.” Accordingly, as used herein, the phrase “first reactive species” should be understood to refer to all species comprising a conjugated, negatively-charged ring including a nitrogen atom. The conjugated, negatively-charged ring including the nitrogen atom in the first reactive species may be referred to throughout as a “reactive ring.” Accordingly, the phrase “reactive ring” should be understood to refer to all conjugated, negatively-charged rings including a nitrogen atom forming part of a first reactive species.

Some embodiments relate to an electrochemical cell including a species comprising a first reactive species and a species reactive with the first reactive species, referred to herein as a “second reactive species.” Accordingly, the phrase “second reactive species” should be understood to refer to all species reactive with the first reactive species.

Reaction of a second reactive species with a first reactive species may produce a reaction product that is desirable in one or more ways. For instance, in some embodiments, the second reactive species may react with the first reactive species to produce a protective layer and/or a component of a protective layer. The protective layer may be capable of protecting an electrode, such as an anode, from deleterious reactions with one or more other species also present in the electrochemical cell, such as one or more species present in the electrolyte. In some embodiments, the protective layer formed by a reaction described herein may be advantageous. By way of example, it may have a relatively low resistance. As another example, the second reactive species may react with the first reactive species to produce a solid electrolyte layer (SEI) and/or a component of an SEI. In some embodiments, the SEI formed by a reaction described herein may be advantageous in comparison to other SEIs in one or more ways. By way of example, the SEI formed by a reaction described herein may be particularly stable, may function as a protective layer, and/or may have a relatively low resistance.

In some embodiments, an electrochemical cell comprises a species comprising a labile halogen atom. The species comprising the labile halogen atom may be a second reactive species. One type of reaction that may occur between a species comprising the labile halogen atom (e.g., a second reactive species) and a first reactive species is a nucleophilic substitution reaction. In this reaction, as shown below in Reaction I, the first reactive species may displace the labile halogen atom from the species comprising the labile halogen atom.

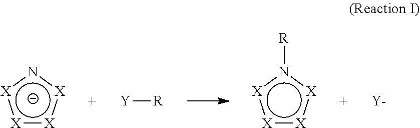

As will be described in further detail below, in Reaction I, each X may be independently selected from the group consisting of —N═ and

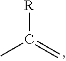

Y may be a halogen atom, and each instance of R may each independently be any suitable R group (e.g., any R group described herein). It should be understood that, although Reaction I shows a first reactive species with a 5-member reactive ring, some embodiments may relate to reactive species comprising reactive rings of other sizes. Such reactive species may also undergo nucleophilic substitution reactions with second reactive species (e.g., second reactive species comprising a labile halogen atom).

The progress of a nucleophilic substitution reaction, such as a nucleophilic substitution reaction described by Reaction I, may be detectable by an NMR measurement, such as a ¹⁹F NMR measurement, a ³¹P NMR measurement, a ¹³C NMR measurement, and/or a ¹H NMR measurement. The NMR measurement may be made on the component(s) of the electrochemical cell comprising the first reactive species (i.e., a species comprising a conjugated, negatively-charged ring including a nitrogen atom) and/or the second reactive species (e.g., the species comprising the labile halogen atom). For instance, in some embodiments, the nucleophilic substitution reaction may cause the electrolyte to undergo a change in composition detectable by the NMR measurement. By way of example, the nucleophilic substitution reaction may cause the concentration of the first reactive species and/or the second reactive species to decrease, and the decrease may be to an extent observable by the NMR measurement. In some embodiments, the reaction product of the nucleophilic substitution reaction comprising a tertiary nitrogen, such as an azole derivative, deposits onto an electrode to form a protective layer, or a component thereof, with desirable properties.

Reaction of a first reactive species (i.e., a species comprising a conjugated, negatively-charged ring including a nitrogen atom) with a metal (e.g., lithium metal or a transition metal) may produce a reaction product that is desirable in one or more ways. For instance, in some embodiments, the first reactive species may react with a metal to produce a protective layer and/or a component of a protective layer. The protective layer may be capable of protecting an electrode, such as an anode (e.g., for lithium) or a cathode (e.g., for a transition metal), from deleterious reactions with one or more other species also present in the electrochemical cell, such as one or more species present in the electrolyte. In some embodiments, the protective layer formed by a reaction described herein may be advantageous. By way of example, it may have a relatively low resistance. As another example, the first reactive species may react with a metal to produce a solid electrolyte layer (SEI) and/or a component of an SEI. In some embodiments, the SEI formed by a reaction described herein may be advantageous in comparison to other SEIs in one or more ways. By way of example, the SEI formed by a reaction described herein may be particularly stable, may function as a protective layer, and/or may have a relatively low resistance.

As described herein, an electrochemical cell may comprise a first electrode. In some embodiments, the first electrode comprises lithium metal (e.g., vacuum deposited lithium). In some embodiments, the first electrode (e.g., the lithium metal) interacts with the first reactive species (i.e., a species comprising a conjugated, negatively-charged ring including a nitrogen atom) and/or with a reaction product thereof. For example, in some embodiments, lithium metal in an electrode comprising lithium metal interacts with a first reactive species (i.e., a species comprising a conjugated, negatively-charged ring including a nitrogen atom) such that a layer is formed (e.g., disposed on the first electrode). In some embodiments, the layer (e.g., protective layer) comprises the first reactive species and/or a reaction product thereof. In some embodiments, the reaction product comprises a reaction product between the lithium metal and the first reactive species. In some embodiments, the reaction product comprises a reaction product between a first reactive species (i.e., a species comprising a conjugated, negatively-charged ring including a nitrogen atom) and a second reactive species (e.g., a species comprising a labile halogen atom). In some embodiments, the reaction product comprises a reaction product between the lithium metal and a reaction product of a first reactive species (i.e., a species comprising a conjugated, negatively-charged ring including a nitrogen atom) and a second reactive species (e.g., a species comprising a labile halogen atom). The first reactive species and/or one or more of these reaction products may deposit onto an electrode (e.g., the electrode comprising lithium metal) to form a layer (e.g., a protective layer), or a component thereof, with desirable properties.

The layer (e.g., protective layer) may be desirable in one or more ways. For instance, in some embodiments, the protective layer may be capable of protecting an electrode, such as an anode (e.g., for lithium) and/or a cathode (e.g., for a transition metal), from deleterious reactions with one or more other species also present in the electrochemical cell, such as one or more species present in the electrolyte. In some embodiments, the layer may have a relatively low resistance. As another example, the layer may be a solid electrolyte layer (SEI) and/or a component of an SEI. In some embodiments, the SEI formed by a reaction described herein may be advantageous in comparison to other SEIs in one or more ways. By way of example, the SEI formed by a reaction described herein may be particularly stable, may function as a protective layer, and/or may have a relatively low resistance.

In some embodiments, an electrochemical cell described herein comprises a layer (e.g., a protective layer) having one or more advantageous properties. In some embodiments, the layer (e.g., protective layer) may comprise, or consist essentially of, an SEI. The SEI may protect the electrode by reducing the area of the electrode exposed directly to the electrolyte and/or by preventing or reducing the rate of reaction between the electrode and the electrolyte. In some embodiments, the layer (e.g., protective layer) comprises a first reactive species and/or one or more reaction products described herein, such as those of a first reactive species (and/or reaction products of such species, such as a reaction product of a species shown on the right hand side of Reaction I), and, in some embodiments, further comprises other species. These other species may include reaction products of the electrode with one or more components of the electrolyte, such as one or more organic solvents. The presence of some of the reaction products described herein may enhance the properties of the SEI in comparison to otherwise equivalent SEIs lacking the reaction product(s). This may be especially true for electrodes that comprise lithium metal or a transition metal, which may interact especially favorably with the first reactive species and/or reaction products of the first reactive species to form a part of the SEI and/or which may react with the first reactive species and/or reaction products of the first reactive species (e.g., reaction products of a reaction between the first reactive species and the second reactive species) to form a reaction product advantageous for inclusion in the SEI. While the reaction products described herein may be especially advantageous when incorporated into the SEI, it should also be understood that the reaction products may, also or instead, be incorporated into other types of protective layers (e.g., protective layers comprising one or more particles or protective layers formed by aerosol deposition).

Some embodiments relate to SEIs that would not typically be considered protective layers for one or more reasons. For instance, some such SEIs do not protect the electrode and/or may be present in an electrochemical cell further comprising a protective layer. Such SEIs may, however, have one or more of the advantageous features described above with respect to protective layers. In some embodiments, an electrochemical cell comprises an SEI that is not a protective layer.

In some embodiments, the reaction product(s) comprises the reaction product of the first reactive species (i.e., a species comprising a conjugated, negatively-charged ring including a nitrogen atom) and a metal (e.g., lithium metal, such as lithium metal of an electrode (e.g., first electrode) comprising lithium metal, or a transition metal, such as transition metal of an electrode (e.g., second electrode) comprising a transition metal); the reaction product of the first reactive species (i.e., a species comprising a conjugated, negatively-charged ring including a nitrogen atom) and the second reactive species (e.g., a species comprising a labile halogen atom); and/or the reaction product of a metal (e.g., lithium metal, such as lithium metal of an electrode (e.g., first electrode) comprising lithium metal, or a transition metal, such as transition metal of an electrode (e.g., second electrode) comprising a transition metal) and the reaction product of the first reactive species (i.e., a species comprising a conjugated, negatively-charged ring including a nitrogen atom) and the second reactive species (e.g., a species comprising a labile halogen atom).

In some embodiments, one or more (e.g., all) of the reaction products comprises covalent and/or coordination bonds. For example, in some embodiments, one or more (e.g., all) of the reaction products comprises covalent and/or coordination bonds with the metal (e.g., the lithium metal and/or transition metal).

In some embodiments, one or more (e.g., all) of the reaction products comprises a polymer. In some embodiments, one or more (e.g., all) of the reaction products comprises a polymeric network (e.g., a 2D polymeric network and/or a 3D polymeric network).

In some embodiments, one or more (e.g., all) of the reaction products is insoluble in the electrolyte. In some embodiments, one or more (e.g., all) of the reaction products is insoluble in one or more (e.g., all) organic solvents (e.g., the non-aqueous organic solvents disclosed herein).

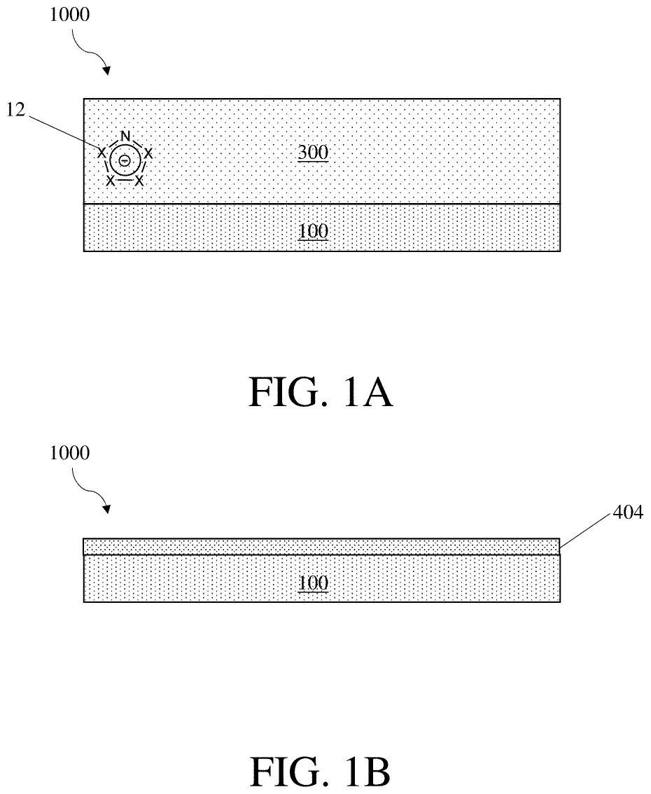

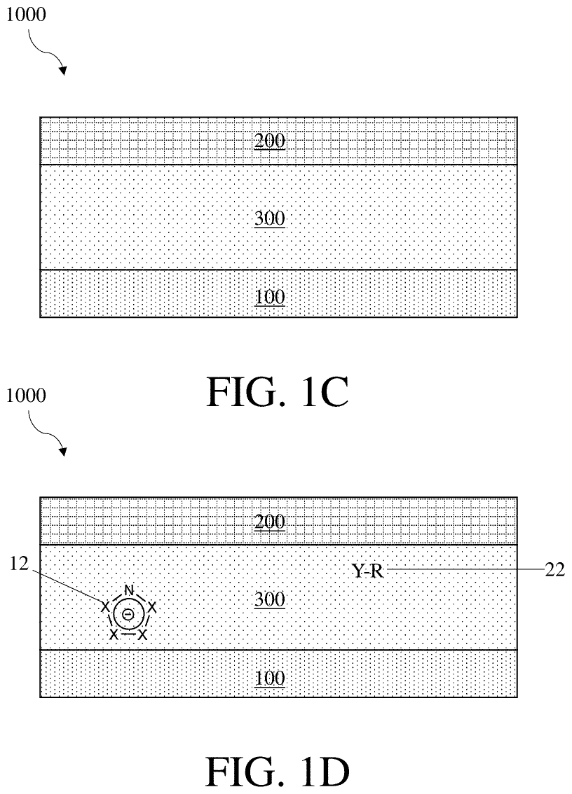

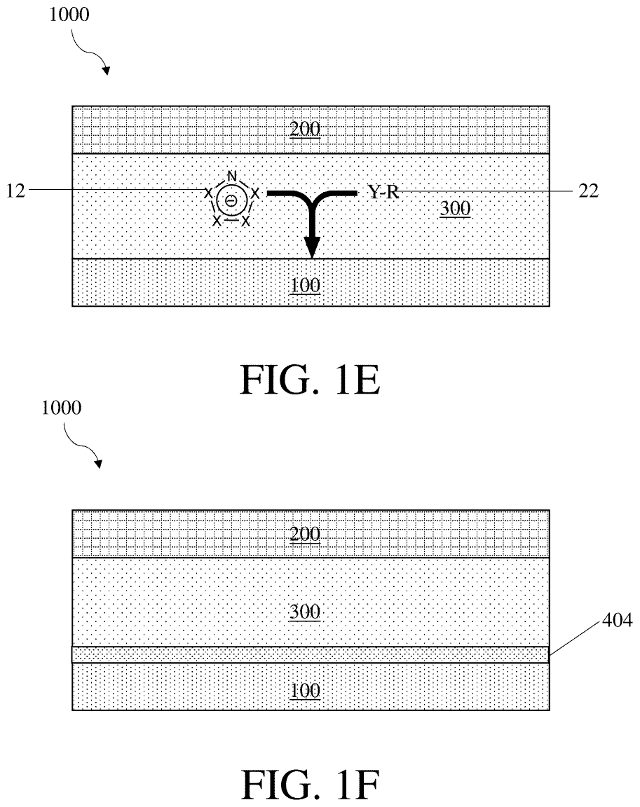

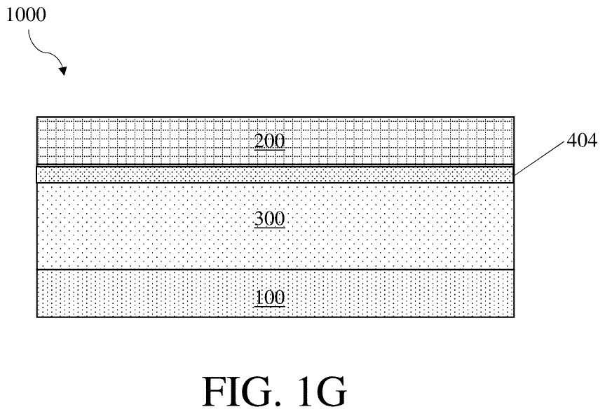

FIGS. 1A-1G show an electrochemical cell that may comprise one or more advantageous components described herein and/or in which one or more advantageous methods described herein may occur. For example, in FIG. 1C, an electrochemical cell 1000 comprises a first electrode 100, an electrolyte 300, and, optionally a second electrode 200. It should be understood that the electrochemical cells shown in FIGS. 1A-1G may optionally include one or more other components not shown, such as a separator, one or more current collectors, housing, external circuitry, species in the electrolyte, protective layer(s), additional electrode(s), and the like.

In some embodiments, one or more components of an electrochemical cell comprises one or more advantageous species. For instance, one or more components of an electrochemical cell may comprise a first reactive species (i.e., a species comprising a conjugated, negatively-charged ring including a nitrogen atom) and/or a second reactive species (e.g., a species comprising a labile halogen atom). For example, in some embodiments, an electrochemical cell comprises an electrolyte comprising a first reactive species (i.e., a species comprising a conjugated, negatively-charged ring including a nitrogen atom). FIG. 1A shows one such electrochemical cell, wherein electrochemical cell 1000 comprises first electrode 100 and electrolyte 300, and wherein electrolyte 300 comprises first reactive species 12. As another example, in some embodiments, an electrochemical cell comprises an electrolyte comprising both of these species. FIG. 1D shows one such electrochemical cell. In FIG. 1D, an electrochemical cell 1000 comprises a first electrode 100, an electrolyte 300, and, optionally, a second electrode 200. Electrolyte 300 in FIG. 1D further comprises a first reactive species 12 and a second reactive species 22. As shown in FIG. 1D, the first reactive species may be a species comprising a conjugated, negatively-charged ring including a nitrogen atom (e.g., an azolate) and/or the second reactive species may be a species comprising a labile halogen atom. In some embodiments, a first electrode in an electrochemical cell (e.g., the first electrode of FIG. 1A, 1C, or 1D) comprises lithium metal. The first electrode may be an anode, and/or the second electrode may be a cathode.

It should be understood that while FIG. 1D shows one possible location for a first reactive species (e.g. within electrolyte 300) and one possible location for a second reactive species (e.g. within electrolyte 300), other locations for these species are also possible. By way of example, one or both of these species may, additionally or alternatively, be present in an electrode (e.g., a second electrode) in an electrochemical cell. For instance, the electrode may comprise pores, and one or both of a first reactive species and a second reactive species may be present in the pores of the electrode. In some embodiments, the electrode is a second electrode (e.g., a cathode). Other possible locations for the first reactive species and the second reactive species include the pores of a separator in an electrochemical cell (e.g., in electrolyte disposed therein) and/or in one or more reservoir(s) from which they may be released into another location in the electrochemical cell (e.g., the electrolyte).

In some embodiments, an electrochemical cell includes a first reactive species, i.e., a species comprising a conjugated, negatively-charged ring including a nitrogen atom, in a first location and a second reactive species, such as a species comprising a labile halogen atom, in a location other than the first location (e.g. a second location). In some embodiments, the first location lacks the second reactive species, and/or the second location lacks the first reactive species. By way of example, an electrochemical cell may include a first reservoir comprising the first reactive species (and, optionally, lacking the second reactive species) and a second reservoir comprising the second reactive species (and, optionally, lacking the first reactive species).

In some embodiments, a single component of an electrochemical cell comprises both the first reactive species (i.e., a species comprising a conjugated, negatively-charged ring including a nitrogen atom) and the second reactive species (e.g., a species comprising the labile halogen atom). By way of example, and as shown illustratively in FIG. 1D, an electrochemical cell may comprise an electrolyte comprising both the first reactive species and the second reactive species. Other combinations of locations for the first reactive species and the second reactive species are also possible.

In some embodiments, the electrochemical cell comprises a layer (e.g., a protective layer, such as an SEI) disposed on a component therein (e.g., an electrode, such as the first electrode or the second electrode). For example, in FIG. 1B, an electrochemical cell 1000 comprises a first electrode 100 and a layer 404 disposed on first electrode 100. In some embodiments, the layer (e.g., a protective layer) comprises the first reactive species and/or a reaction product thereof (e.g., a reaction product disclosed herein). For example, in some embodiments, the layer comprises the first reactive species. As another example, in some embodiments, the layer comprises a reaction product between a metal (e.g., lithium metal and/or a transition metal in an electrode) and the first reactive species (i.e., a species comprising a conjugated, negatively-charged ring comprising a nitrogen atom). As yet another example, in some embodiments, the layer comprises a reaction product between the first reactive species (i.e., a species comprising a conjugated, negatively-charged ring comprising a nitrogen atom) and a second reactive species (e.g., a species comprising the labile halogen atom). As yet another example, in some embodiments, the layer comprises a reaction product between a reaction product (e.g., the reaction product of the first reactive species and the second reactive species) and a metal (e.g., lithium metal and/or a transition metal in an electrode).

As described above, some methods described herein relate to forming advantageous layers (e.g., a layer comprising a first reactive species and/or a reaction product thereof) and/or reaction products of a first reactive species. Such methods can be understood in relation to FIGS. 1A-1G. In some embodiments, the method comprises placing a volume of an electrolyte in an electrochemical cell. For example, in some embodiments, the method comprises placing a volume of electrolyte 300 in electrochemical cell 1000, as shown in FIG. 1C. In some embodiments, the volume of the electrolyte is sufficient to fill most (e.g., greater than or equal to 90%, greater than or equal to 95%, or greater than or equal to 99%) or all (i.e., 100%) of the pores of the first electrode, second electrode, and/or separator.

In some embodiments, the electrolyte comprises a first reactive species (i.e., a species comprising a conjugated, negatively-charged ring comprising a nitrogen atom). For example, in some embodiments, the method comprises placing electrolyte 300 in electrochemical cell 1000, which comprises first electrode 100, as shown in FIG. 1C, wherein electrolyte 300 comprises first reactive species 12. In some such embodiments, the first electrode (e.g., first electrode 100 in FIG. 1C) comprises lithium metal.

In some such embodiments, the first reactive species interacts with and/or reacts with the lithium metal. In some embodiments, the method comprises forming a protective layer on the first electrode. The protective layer may, in some embodiments, comprise the first reactive species and/or a reaction product thereof (e.g., a reaction product between the lithium metal and the first reactive species). For example, in some embodiments, the method further comprises forming layer 404 on first electrode 100, as shown in FIG. 1D, wherein layer 404 comprises a first reactive species and/or a reaction product thereof (e.g., a reaction product between the lithium metal (e.g., in electrode 100) and the first reactive species (i.e., a species comprising a conjugated, negatively-charged ring comprising a nitrogen atom)).

In some embodiments, the electrolyte is placed in the electrochemical cell prior to an initial use (e.g., prior to an initial charge-discharge cycle, or prior to 5^{th}, 10^{th}, 15^{th}, or 20^{th} charge-discharge cycles). For example, in some embodiments, the electrolyte is placed in the electrochemical cell prior to an initial use, such that there is sufficient time for a reaction product(s) and/or layer (e.g., protective layer) to be formed. In some embodiments, the electrolyte is placed in the electrochemical cell at least 24 hours, at least 36 hours, at least 48 hours, or at least 72 hours prior to an initial use (e.g., 1-7 days prior to an initial use (e.g., prior to an initial charge-discharge cycle, or prior to 5^{th}, 10^{th}, 15^{th}, or 20^{th} charge-discharge cycles)).

FIGS. 1E-1G show another exemplary method by which such layers and/or reaction products may be formed. In some embodiments, the electrolyte comprises a first reactive species (i.e., a species comprising a conjugated, negatively-charged ring comprising a nitrogen atom) and/or a second reactive species (e.g., a species comprising a labile halogen atom). In FIGS. 1E-1G, electrolyte 300 of an electrochemical cell 1000 comprises a first reactive species 12 (i.e., a species comprising a conjugated, negatively-charged ring including a nitrogen atom) and a second reactive species 22 (e.g., a species comprising a labile halogen atom). In some embodiments, first reactive species 12 reacts with second reactive species 22 to form a layer 404 disposed on a first electrode 100 comprising a reaction product. In some embodiments, the reaction product comprises a reaction product of the first reactive species and the second reactive species. In some embodiments, first electrode 100 comprises lithium metal. In some such embodiments, the reaction product comprises a reaction product between lithium metal, the first reactive species and the second reactive species (e.g., a reaction product between lithium metal and the reaction product of the first reactive species and the second reactive species). In some embodiments, the electrochemical cell 1000 further includes a second electrode 200. In some embodiments, the first electrode may be an anode, and/or the second electrode may be a cathode.

In some embodiments, the layer (e.g., layer 404 shown in FIGS. 1B and 1F) is a protective layer. As described above, the protective layer may be an SEI, may be a structure other than an SEI, and/or may include components other than the species (e.g., first reactive species and second reactive species) and reaction products discussed above (e.g., may include a reaction product of one or more electrolyte components with the first electrode and/or a ceramic deposited onto the first electrode prior to cell assembly). In some embodiments, the layer is an SEI that is not a protective layer.

It should also be understood that FIGS. 1C-1F are exemplary, and that other variations from FIGS. 1C-1F not described herein are also possible. For instance, some embodiments relate to protective layers comprising advantageous species (e.g., the first reactive species) and/or reaction products formed by methods other than that shown in FIGS. 1E-1F (e.g., formed by methods that take place prior to electrochemical cell assembly). As another example, some processes and/or reactions described herein, such as the deposit of the first reactive species and/or a reaction of the first reactive species (e.g., between the first reactive species and lithium metal, between the first reactive species and the second reactive species, or between lithium metal, the first reactive species, and the second reactive species (e.g., between lithium metal and the reaction product formed between the first reactive species and the second reactive species)), may result in the formation of an advantageous structure other than a layer and/or may result in the formation of an advantageous reaction product that is incorporated into an existing structure already present in the electrochemical cell (e.g., an SEI, a previously-formed protective layer, an electrode, an electrolyte).

When present, a first reactive species (i.e., a species comprising a conjugated, negatively-charged ring including a nitrogen atom) may make up a variety of suitable amounts of an electrochemical cell. Although the first reactive species may be present in portions of the electrochemical cell other than the electrolyte (in addition to or instead of being present in the electrolyte), it may be convenient to describe the amount of the first reactive species with reference to the amount of the electrolyte. Therefore, the wt % ranges listed below are with respect to the total weight of the electrolyte, including any first reactive species present therein and any counter ions therein. Additionally, it should be understood that the ranges listed below may refer to any of the following: (1) the total amount of a particular first reactive species and any counter ion(s) in the electrochemical cell as a whole; (2) the amount of a particular first reactive species and any counter ion(s) in the electrolyte (with further amounts of the first reactive species, or not); (3) the amount of all first reactive species and any counter ions in the electrochemical cell as a whole; and (4) the amount of all first reactive species and any counter ions in the electrolyte (with further amounts of the first reactive species in other locations in the electrochemical cell, or not).

In some embodiments, an electrochemical cell comprises a first reactive species (i.e., a species comprising a conjugated, negatively-charged ring including a nitrogen atom) and any counter ion(s) thereof in an amount of greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, or greater than or equal to 3 wt % versus the total weight of the electrolyte. In some embodiments, an electrochemical cell comprises a first reactive species and its counter ion(s) in an amount of less than or equal to 5 wt %, less than or equal to 3 wt %, less than or equal to 2 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, less than or equal to 0.05 wt %, or less than or equal to 0.02 wt % versus the total weight of the electrolyte. Combinations of the above-referenced ranges are also possible (e.g., greater than or equal to 0.01 wt % and less than or equal to 5 wt %, or greater than or equal to 1 wt % and less than or equal to 3 wt %). Other ranges are also possible.

A variety of first reactive species may be appropriate for inclusion in the electrochemical cells described herein. As described above, the first reactive species comprises a conjugated, negatively-charged ring including a nitrogen atom (i.e., a “reactive ring”). In some embodiments, the first reactive species and/or reactive ring comprises more than one nitrogen atom (e.g., greater than or equal to 2 nitrogen atoms or greater than or equal to 3 nitrogen atoms; less than or equal to 5 nitrogen atom, less than or equal to 4 nitrogen atoms, less than or equal to 3 nitrogen atoms, or less than or equal to 2 nitrogen atoms; combinations thereof are also possible, such as 1-5 nitrogen atoms or 2-3 nitrogen atoms).

In some embodiments, the first reactive species and/or reactive ring comprises a substituted or unsubstituted 1,2,4-triazole, substituted or unsubstituted 1,2,3-triazole, substituted or unsubstituted 1,3,4-triazole, substituted or unsubstituted pyrazole, substituted or unsubstituted imidazole, substituted or unsubstituted tetrazole, substituted or unsubstituted benzimidazole, substituted or unsubstituted indazole, and/or substituted or unsubstituted benzotriazole. In some embodiments, the first reactive species and/or reactive ring comprises a pyrrolate derivative, an azolate derivative, an imidazolate derivative, a pyrazolate derivative, and/or a triazolate derivative.

In some embodiments, the first reactive species and/or reactive ring is substituted (e.g., mono-substituted or poly-substituted). Examples of suitable substituents include alkyl, aryl, alkoxy, aryloxy, nitro, amino, thio, fluoro, chloro, bromo, iodo, and/or phosphate substituents, and/or any substituent disclosed herein.

Some first reactive species may have one or more structural features that are particularly advantageous. In some embodiments, first reactive species that are particularly reactive with species comprising a labile halogen atom may be particularly desirable. In other words, in some embodiments, it may be particularly desirable for the second reactive species to be a species comprising a labile halogen atom and for the first reactive species to be particularly reactive with such species. Thus, chemical properties of the first reactive species that promote reaction with the species comprising a labile halogen atom may also be desirable, in some embodiments. These chemical properties may include, for example, a negative charge that delocalizes to a relatively high degree over the reactive ring.

Without wishing to be bound by any particular theory, electron withdrawing groups may reduce the reactivity of the reactive ring and/or first reactive species (e.g., in nucleophilic substitution reactions, in reactions with the second reactive species, and/or in reactions with metals (e.g., lithium metal and/or transition metal)), while electron donating groups may increase the reactivity of the reactive ring and/or first reactive species (e.g., in nucleophilic substitution reactions, in reactions with the second reactive species, and/or in reactions with metals (e.g., lithium metal and/or transition metal)). Without wishing to be bound by any particular theory, a localized negative charge on a reactive ring may increase the reactivity of the reactive ring and/or first reactive species (compared to a relatively more delocalized negative charge) (e.g., in nucleophilic substitution reactions, in reactions with the second reactive species, and/or in reactions with metals (e.g., lithium metal and/or transition metal)).

Structural features of the reactive ring that may cause it to have one or more advantageous chemical properties are described in further detail below.

As described above, it may be beneficial for a first reactive species to be negatively charged. In some embodiments, the first reactive species is charged as a whole. The charge may be a negative charge; i.e., the first reactive species may be an anion. In some embodiments, the first reactive species is a monovalent anion. When charged, the first reactive species may have one or more counter ions. The counter ion(s) may be present in the same location(s) in the electrochemical cell as the first reactive species, such as the electrolyte and/or the second electrode. Further details regarding suitable counter ions will be provided below.

In some embodiments, the presence of certain functional groups (e.g., electron-withdrawing groups, such as strong electron-withdrawing groups) on the first reactive species is disadvantageous. Accordingly, in some embodiments, such disadvantageous functional groups (e.g., electron-withdrawing groups, such as strong electron-withdrawing groups) are absent from the first reactive species and/or reactive ring.

In other embodiments, a first reactive species and/or reactive ring includes one or more functional groups that may be disadvantageous in limited amounts. By way of example, some first reactive species and/or reactive rings include a relatively small number of electron-withdrawing groups in total and/or in some locations. For instance, the first reactive species and/or reactive ring may include at most one electron-withdrawing group. In other embodiments, the first reactive species and/or reactive ring includes more than one electron-withdrawing group but still includes relatively few electron-withdrawing groups. For instance, the first reactive species and/or reactive ring may include at most two or at most three electron-withdrawing groups. Without wishing to be bound by any particular theory, it is believed that electron-withdrawing groups may reduce the reactivity of the reactive ring (e.g., in nucleophilic substitution reactions, in reactions with the second reactive species, and/or in reactions with metals (e.g., lithium metal and/or transition metal). For example, it is believed that the electron-withdrawing groups may make it less likely to, e.g., attack the relatively electropositive portion of the species comprising the labile halogen atom to which the labile halogen atom is attached. This reduction in reactivity may undesirably cause the formation of one or more reaction products (e.g., a reaction product between the metal (e.g., lithium metal or transition metal) and the first reactive species; a reaction product between the first reactive species and the second reactive species; and/or a reaction product between the metal, the first reactive species, and the second reactive species (e.g., a reaction product between the metal and the reaction product between the first reactive species and the second reactive species) to occur more slowly or not all.

Electron-withdrawing groups are typically classified into strong electron-withdrawing groups, moderate electron-withdrawing groups, and weak electron-withdrawing groups, examples of which are provided below. Strong electron-withdrawing groups are believed to provide the above-mentioned undesirable effects to a greater degree than moderate electron-withdrawing groups, and moderate electron-withdrawing groups are believed to provide the above-mentioned undesirable effects to a greater degree than weak electron-withdrawing groups. In some embodiments, a first reactive species and/or reactive ring comprises one or more moderate and/or weak electron-withdrawing groups but no strong electron-withdrawing groups, or comprises one or more weak electron-withdrawing groups but no moderate or strong electron-withdrawing groups. In some embodiments, a first reactive species and/or reactive ring comprises no weak, moderate, or strong electron-withdrawing groups (i.e., a first reactive species and/or reactive ring comprises no electron-withdrawing groups).

In some embodiments, a first reactive species and/or reactive ring may comprise at most one, at most two, or at most three strong electron-withdrawing groups. A first reactive species and/or reactive ring may comprise at most one, at most two, or at most three moderate electron-withdrawing groups. A first reactive species and/or reactive ring may comprise at most one, at most two, or at most three weak electron-withdrawing groups. Suitable combinations of the above are also possible (e.g., a first reactive species and/or reactive ring may comprise between one and three electron-withdrawing groups, between one and three strong electron-withdrawing groups, between one and three moderate electron-withdrawing groups, or between one and three weak electron-withdrawing groups).

Non-limiting examples of strong electron-withdrawing groups include triflyl groups, trihalide groups, cyano groups, sulfonate groups, nitro groups, ammonium groups, and quaternary amine groups. Non-limiting examples of moderate electron-withdrawing groups include aldehyde groups, ketone groups, carboxylic acid groups, acyl chloride groups, ester groups, and amide groups. Non-limiting examples of weak electron-withdrawing groups include halide groups, phosphate groups, thiocyanate groups, isocyanate groups, isothiocyanate groups, and thiocarbamate groups.

In some embodiments, a first reactive species and/or reactive ring comprises one or more functional groups that may be advantageous. The first reactive species and/or reactive ring may comprise these functional groups in relatively higher amounts compared to other first reactive species and/or compared to the number of other types of functional groups (e.g., functional groups that are not advantageous and/or functional groups that are disadvantageous) present in the first reactive species and/or reactive ring. By way of example, some first reactive species and/or reactive rings include a relatively large number of electron-donating groups in total and/or in some locations. For instance, the first reactive species and/or reactive ring may include one or more electron-donating groups. In some embodiments, the first reactive species and/or reactive ring including the nitrogen atom comprises at least two, at least three, or more electron-donating groups. In other embodiments, the first reactive species and/or reactive ring lacks electron-donating groups.

Without wishing to be bound by any particular theory, it is believed that electron-donating groups may enhance the reactivity of a reactive ring (e.g., in nucleophilic substitution reactions, in reactions with the second reactive species, and/or in reactions with metals (e.g., lithium metal and/or transition metal)). It is believed that this occurs for similar reasons described above with respect to electron-withdrawing groups, namely, that the electron-donating groups increase the charge on the reactive ring (compared to reactive rings lacking the electron-withdrawing group, all other factors being equal). The increased charge on the reactive ring may make it more likely to react (e.g., in nucleophilic substitution reactions, in reactions with the second reactive species, and/or in reactions with metals (e.g., lithium metal and/or transition metal)). For instance, when the second reactive species is a species comprising a labile halogen atom, the increased charge on the reactive ring may allow it to attack the relatively electropositive portion of the species comprising the labile halogen atom to which the labile halogen atom is attached. This may advantageously cause the formation of the desirable reaction product shown in Reaction I to occur more rapidly.

In some embodiments, a first reactive species and/or reactive ring comprises one or more electron-donating groups and an electron-withdrawing group (e.g., at most one electron-withdrawing group). In some embodiments, a first reactive species and/or reactive ring comprises the same number of electron-donating groups and electron-withdrawing groups. In some embodiments, a first reactive species and/or reactive ring comprises more electron-donating groups than electron-withdrawing groups. In some embodiments, the total strength of electron-donating groups on a first reactive species and/or reactive ring is higher than the total strength of electron-withdrawing groups on a first reactive species and/or reactive ring (e.g., if a first reactive species and/or reactive ring had a strong electron-donating group and a weak electron-withdrawing group). Without wishing to be bound by any particular theory, it is believed that the presence of one or more electron-donating groups may offset the negative effects of the electron-withdrawing groups described above.

Electron-donating groups are typically classified into strong electron-donating groups, moderate electron-donating groups, and weak electron-donating groups. Strong electron-donating groups are believed to provide the above-mentioned desirable effects to a greater degree than moderate electron-donating groups, and moderate electron-donating groups are believed to provide the above-mentioned desirable effects to a greater degree than weak electron-donating groups. In some embodiments, a first reactive species and/or reactive ring includes one or more strong electron-donating groups but no moderate or weak electron-donating groups, or includes one or more strong and/or moderate electron-donating groups but no weak electron-donating groups. A first reactive species and/or reactive ring may comprise at least one, at least two, or at least three strong electron-donating groups. A first reactive species and/or reactive ring may comprise at least one, at least two, or at least three moderate electron-donating groups. A first reactive species and/or reactive ring may include at least one, at least two, or at least three weak electron-donating groups. Suitable combinations of the above are also possible (e.g., a first reactive species and/or reactive ring may comprise between one and three electron-donating groups, between one and three strong electron-donating groups, between one and three moderate electron-donating groups, or between one and three weak electron-donating groups). In some embodiments, a first reactive species and/or reactive ring has no strong electron-donating groups, no moderate electron-donating groups, and/or no weak electron-donating groups.

Non-limiting examples of strong electron-donating groups include oxide groups, thiolate groups, tertiary amine groups, secondary amine groups, primary amine groups, ether groups, thioether groups, alcohol groups, thiol groups, and some alkoxy groups. Non-limiting examples of moderate electron-donating groups include amide groups, thioamide groups, ester groups, thioate groups, dithioate groups, thioester groups, and some alkoxy groups. Non-limiting embodiments of weak electron-donating groups include aliphatic groups (e.g., alkyl groups), aromatic groups (e.g., phenyl groups), heteroaromatic groups, and vinyl groups.

In some embodiments, a first reactive species may have one or more chemical properties indicative of an advantageous level of reactivity (e.g., with a metal, such as a lithium metal or transition metal, or with a second reactive species, such as a species comprising a labile halogen atom). These chemical properties may include, for example, a lack of stability in some chemical environments, which may give an indication of the general reactivity of the first reactive species. By way of example, in some embodiments, the first reactive species is unstable in water at standard pressure and temperature conditions.

A first reactive species may comprise a variety of suitable numbers of rings. Such a species may be monocyclic or may be polycyclic. In some embodiments where the first reactive species is monocyclic, the first reactive species and/or reactive ring is a 5-membered ring, a 6-membered ring, a 9-membered ring, a 12-membered ring, or a 16-membered ring. When the first reactive species is polycyclic, it may be bicyclic, tricyclic, or may include four or more rings. Each ring present in a polycyclic first reactive species may be a variety of sizes. For instance, a polycyclic first reactive species may comprise a 5-membered ring, a 6-membered ring, a 9-membered ring, a 12-membered ring, a 16-membered ring, and/or combinations thereof. In some embodiments, a polycyclic first reactive species comprises both a 5-membered ring and a 6-membered ring. In some embodiments, a polycyclic first reactive species comprises two 6-membered rings (e.g., in addition to a 5-membered ring).

In some embodiments, a first reactive species may have a structure as shown below:

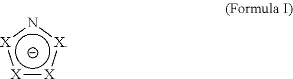

In some embodiments of Formula I: each instance of X may independently be selected from the group consisting of —N═ and

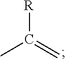

wherein each instance of R may independently be selected from the group consisting of hydrogen, optionally substituted alkyl, alkoxy, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile, or, optionally, wherein any two instances of R are joined to form a ring.

In some embodiments of Formula I: each instance of X may independently be selected from the group consisting of —N═ and

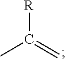

wherein each instance of R may independently be selected from the group consisting of hydrogen, optionally substituted alkyl, alkoxy, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, optionally substituted sulfide, or, optionally, wherein any two instances of R are joined to form a ring.

In some embodiments, a first reactive species has a structure as in Formula I, and at most one instance of R, or no instance of R, is an electron-withdrawing group. In some embodiments, a first reactive species has a structure as in Formula I, and at least one instance of R (or at least two instances of R, at least three instances of R, or four instances of R) is an electron-donating group. In some embodiments, a first reactive species has a structure as in Formula I, and comprises one instance of R that is an electron-withdrawing group and at least one instance of R that is an electron-donating group. Molecules with the structure shown in Formula I may be referred to elsewhere herein as “azolates.”

In some embodiments, no instance of X is —N═ and four instances of X are —CR═. In some embodiments, one instance of X is —N═ and three instances of X are —CR═. In some embodiments, two instances of X are —N═ and two instances of X are —CR═. In some embodiments, three instances of X are —N═ and one instance of X is —CR═.

In some embodiments, no two instances of R are joined to form a ring. In some embodiments, two instances of R are joined to form a ring (e.g., a first aromatic ring). In some embodiments, the first aromatic ring comprises at least one nitrogen atom. In some embodiments, two instances of R are joined to form a first ring (e.g., a first aromatic ring) and two instances of R are joined to form a second ring (e.g., a second aromatic ring). In some such embodiments, at least one of the first and second aromatic rings comprises at least one nitrogen atom.

In Formula I, the negative charge is shown as being delocalized over the five-membered ring of Formula I. For some first reactive species, such as some azolates, Formula I may appropriately show the distribution of charge. For other species, a representation in which the negative charge is localized to one or more atoms or regions of the molecule is more representative of the actual charge distribution in the molecule. Formula IA, below, shows one such representation of the molecule shown in Formula I.

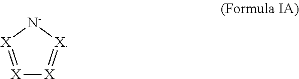

It should be understood that first reactive species may have a variety of distributions of the negative charge, including a distribution like that shown in Formula I, a distribution like that shown in Formula IA, and distributions other than those shown in Formulas I and IA. It should also be understood that the depiction of the distribution of charge in the chemical structure of a molecule is not limiting, and that references to Formulas shown herein should be understood to refer to the arrangement of atoms shown in the Formula but not necessarily the distribution of charge shown in the Formula.

In some embodiments, a first reactive species has a structure as in Formula I and at least two instances of X are

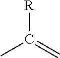

and at least two instances of R are joined to form a ring. In other words, two groups attached to the reactive ring (e.g., in the 1,2-position of a double bond therein) may form, together with one or more atoms forming the reactive ring, a first further ring fused to the reactive ring. The first further ring fused to the reactive ring may be substituted or unsubstituted, unsaturated or saturated, and heterocyclic or homocyclic. In some embodiments, the first further fused ring is a 5-membered ring or a 6-membered ring. One or more further rings may optionally be fused to the first fused ring and/or the reactive ring. These additional rings may each, independently, be substituted or unsubstituted, unsaturated or saturated, heterocyclic or homocyclic, and may have a variety of suitable ring sizes (e.g., 5-membered ring or 6-membered ring). An example of such a structure is shown illustratively in Formula IB.

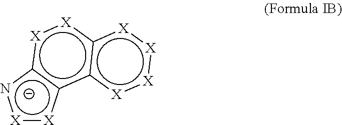

In some embodiments, a first reactive species comprises two further fused rings (in addition to the reactive ring) that are not directly fused to each other. For instance, two sets of groups attached in the 1,2-positions of two double bonds of the reactive ring may each form separate rings, each of which includes one of the double bonds. Each of these additional rings may, independently, be substituted or unsubstituted, unsaturated or saturated, heterocyclic or homocyclic, and may have a variety of suitable ring sizes (e.g., 5-membered ring or 6-membered ring). An example of such a structure is shown illustratively in Formula IC.

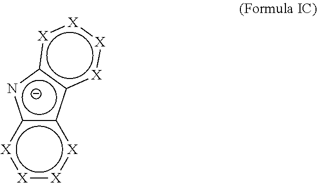

In other embodiments, fewer than two instances of X are

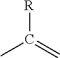

and/or no two instances of R are joined to form a ring.

In some embodiments, an electrochemical cell comprises a first reactive species having a structure as in Formula I for which each instance of X is independently

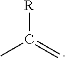

This structure is shown below in Formula II.

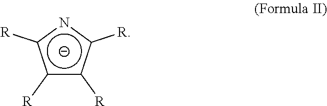

In some embodiments of Formula II, each instance of R is independently selected from the group consisting of hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile, or, optionally, wherein any two instances of R are joined to form a ring.

In some embodiments of Formula II, each instance of R is independently selected from the group consisting of hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, optionally substituted sulfide, or, optionally, wherein any two instances of R are joined to form a ring.

In some embodiments, a first reactive species has a structure as in Formula II, and at most one instance of R, or no instance of R, is an electron-withdrawing group. In some embodiments, a first reactive species has a structure as in Formula II, and at least one instance of R (or at least two instances of R, at least three instances of R, or four instances of R) is an electron-donating group. In some embodiments, a first reactive species has a structure as in Formula I, and comprises one instance of R that is an electron-withdrawing group and at least one instance of R that is an electron-donating group. Molecules having the structure shown in Formula II may be referred to elsewhere herein as “pyrrolates.”

In some embodiments, a first reactive species has a structure as in Formula II and two instances of R are joined together to form a ring. Several such first reactive species are shown below:

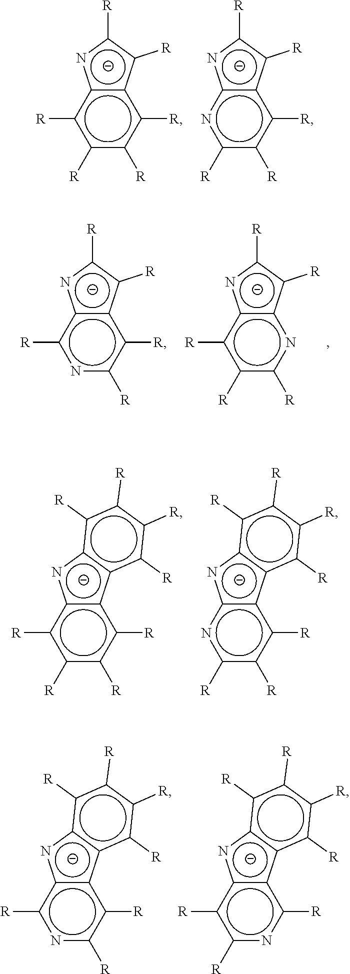

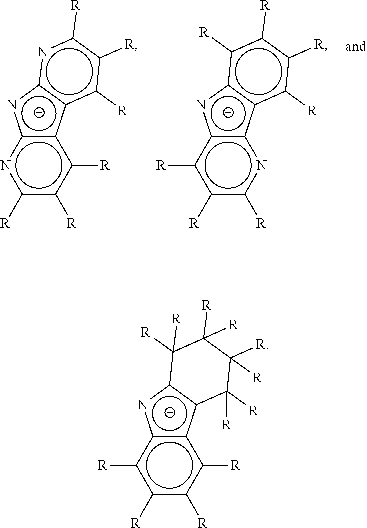

For each of the structures shown above, in some embodiments, each instance of R is independently selected from the group consisting of hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile. In some embodiments, at least two instances of R are joined to form a further ring in addition to the rings shown in the structures above.

For each of the structures shown above, in some embodiments, each instance of R is independently selected from the group consisting of hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted oxyacyloxy, optionally substituted aminoacyl, azide, optionally substituted amino, optionally substituted phosphine, or optionally substituted sulfide. In some embodiments, at least two instances of R are joined to form a further ring in addition to the rings shown in the structures above.

In some embodiments, an electrochemical cell comprises a first reactive species having a structure as in Formula I for which three instances of X are

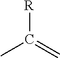

and one instance of X is —N=. One possible structure having this feature is shown below in Formula III.

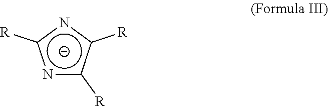

In Formula III, in some embodiments, each instance of R is independently selected from the group consisting of hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile, or at least two instances of R are joined to form a further ring in addition to the rings shown in the structures above.

In some embodiments of Formula III, each instance of R is independently selected from the group consisting of hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide, or at least two instances of R are joined to form a further ring in addition to the rings shown in the structures above.

In some embodiments, a first reactive species has a structure as in Formula III, and at most one instance of R, or no instance of R, is an electron-withdrawing group. In some embodiments, a first reactive species has a structure as in Formula III, and at least one instance of R (or at least two instances of R, or three instances of R) is an electron-donating group. In some embodiments, a first reactive species has a structure as in Formula III, and comprises one instance of R that is an electron-withdrawing group and at least one instance of R that is an electron-donating group. Molecules having the structure shown in Formula III may be referred to elsewhere herein as “imidazolates.”

In some embodiments, a first reactive species has a structure as in Formula III and two instances of R are joined together to form a ring. Two such first reactive species are shown below:

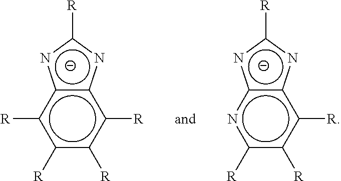

For each of the structures shown above, in some embodiments, each instance of R is independently selected from the group consisting of hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile. In some embodiments, at least two instances of R are joined to form a further ring in addition to the rings shown in the structures above.

For each of the structures shown above, in some embodiments, each instance of R is independently selected from the group consisting of hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide. In some embodiments, at least two instances of R are joined to form a further ring in addition to the rings shown in the structures above.

Another possible structure for a first reactive species having a structure as in Formula I for which three instances of X are

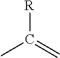

and one instance of X is —N═ is shown below in Formula IV.

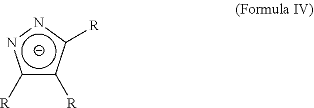

In some embodiments of Formula IV, each instance of R is independently selected from the group consisting of hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile. In some embodiments, at least two instances of R are joined to form a further ring in addition to the rings shown in the structures above.

In some embodiments of Formula IV, each instance of R is independently selected from the group consisting of hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide. In some embodiments, at least two instances of R are joined to form a further ring in addition to the rings shown in the structures above.

In some embodiments, a first reactive species has a structure as in Formula IV, and at most one instance of R, or no instance of R, is an electron-withdrawing group. In some embodiments, a first reactive species has a structure as in Formula IV, and at least one instance of R (or at least two instances of R, or three instances of R) is an electron-donating group. In some embodiments, a first reactive species has a structure as in Formula IV, and comprises one instance of R that is an electron-withdrawing group and at least one instance of R that is an electron-donating group. Molecules having the structure shown in Formula IV may be referred to elsewhere herein as “pyrazolates.”

In some embodiments, a first reactive species has a structure as in Formula IV and two instances of R are joined together to form a ring. One such first reactive species is shown below:

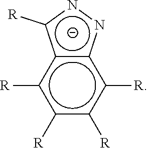

For the structure shown above, in some embodiments, each instance of R is independently selected from the group consisting of hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile. In some embodiments, at least two instances of R are joined to form a further ring in addition to the rings shown in the structure above.

For the structure shown above, in some embodiments, each instance of R is independently selected from the group consisting of hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide. In some embodiments, at least two instances of R are joined to form a further ring in addition to the rings shown in the structure above.

In some embodiments, an electrochemical cell comprises a first reactive species having a structure as in Formula I for which two instances of X are

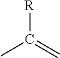

and two instances of X are —N=. Molecules with this feature may be referred to elsewhere herein as “triazolates.” One possible structure having this feature is shown below in Formula V.

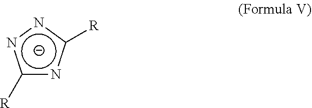

In some embodiments of Formula V, each instance of R is independently selected from the group consisting of hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile. In some embodiments, at least two instances of R are joined to form a further ring in addition to the rings shown in the structure above.

In some embodiments of Formula V, each instance of R is independently selected from the group consisting of hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide. In some embodiments, at least two instances of R are joined to form a further ring in addition to the rings shown in the structure above.

In some embodiments, a first reactive species has a structure as in Formula V, and at most one instance of R, or no instance of R, is an electron-withdrawing group. In some embodiments, a first reactive species has a structure as in Formula V, and at least one instance of R (or two instances of R) is an electron-donating group. In some embodiments, a first reactive species has a structure as in Formula V, and comprises one instance of R that is an electron-withdrawing group and one instance of R that is an electron-donating group. In some embodiments, a first reactive species has a structure as in Formula V and two instances of R are joined together to form a ring.

Another possible structure for a first reactive species having a structure as in Formula I for which two instances of X are

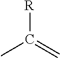

and two instances of X are —N═ is shown below in Formula VI.

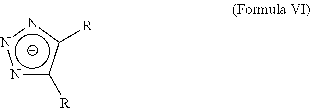

In some embodiments of Formula VI, each instance of R is independently selected from the group consisting of hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile. In some embodiments, at least two instances of R are joined to form a further ring in addition to the rings shown in the structure above.

In some embodiments of Formula VI, each instance of R is independently selected from the group consisting of hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide. In some embodiments, at least two instances of R are joined to form a further ring in addition to the rings shown in the structure above.

In some embodiments, a first reactive species has a structure as in Formula VI, and at most one instance of R, or no instance of R, is an electron-withdrawing group. In some embodiments, a first reactive species has a structure as in Formula VI, and at least one instance of R (or two instances of R) is an electron-donating group. In some embodiments, a first reactive species has a structure as in Formula VI, and comprises one instance of R that is an electron-withdrawing group and one instance of R that is an electron-donating group. In some embodiments, a first reactive species has a structure as in Formula VI and two instances of R are joined together to form a ring.

In some embodiments, an electrochemical cell comprises a first reactive species having a structure as in Formula I for which one instance of X is

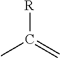

and three instances of X are —N=. Molecules with this feature may be referred to elsewhere herein as “tetrazolates.” This structure is shown below in Formula VII.

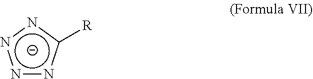

In some embodiments of Formula VI, R is selected from the group consisting of hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocyanate, or nitrile. R may be an electron-withdrawing group, an electron-donating group, or neither.

In some embodiments of Formula VI, R is selected from the group consisting of hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide.

In some embodiments, the first reactive species of Formula I

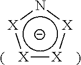

has one of the following structures:

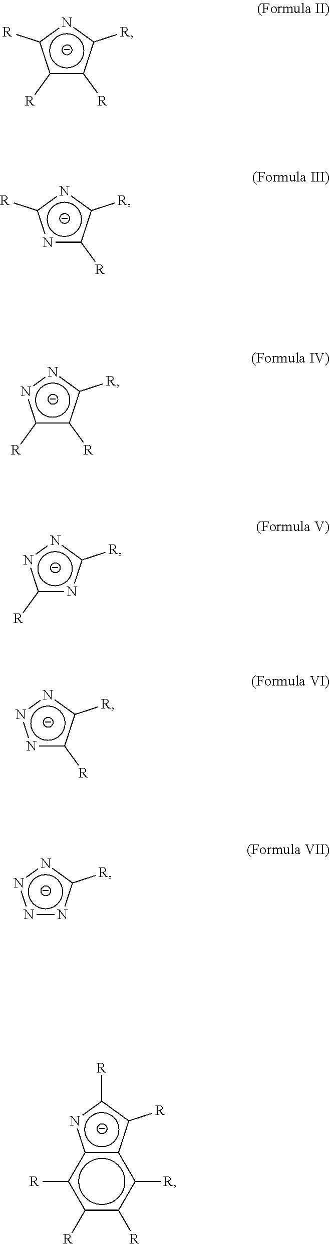

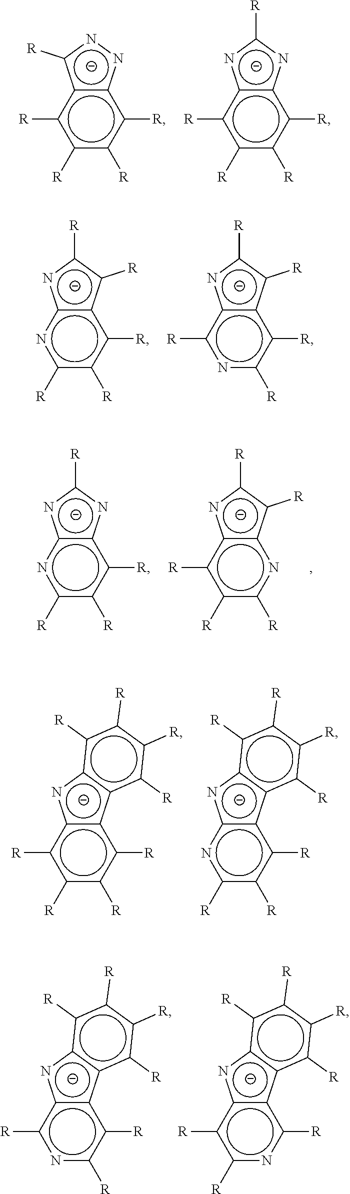

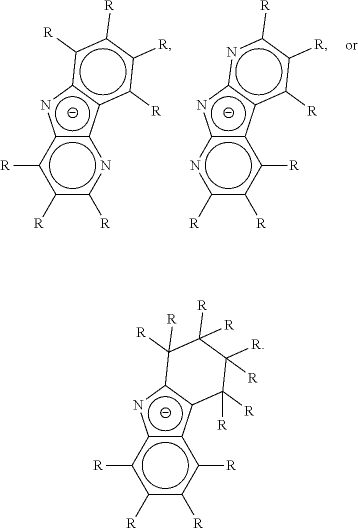

For the structures shown above, in some embodiments, each instance of R is independently hydrogen, optionally substituted alkyl, alcohol, halo, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, nitro, optionally substituted sulfonyl, optionally substituted acyl, optionally substituted oxyacyloxy, optionally substituted aminoacyl, azide, optionally substituted amino, optionally substituted phosphine, optionally substituted sulfide, isonitrile, cyanate, isocynanate, or nitrile; and optionally, wherein any two instances of R are joined to form a ring.

For the structures shown above, in some embodiments, each instance of R is independently hydrogen, optionally substituted alkyl, alcohol, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide; and optionally, wherein any two instances of R are joined to form a ring.

A wide variety of suitable counter ions may be provided with a first reactive species (i.e., a species comprising a conjugated, negatively-charged ring including a nitrogen atom) and/or the first reactive species may comprise a counter ion. In some embodiments, the counter ion is a monovalent counter ion. For instance, in some embodiments, the counter ion(s) comprise one or more alkali metal cations, such as Li⁺, Na⁺, K⁺, Rb⁺, Fr⁺ and/or Cs⁺. In some embodiments, the counter ion is a multivalent counter ion, such as a bivalent counter ion, a trivalent counter ion, or a counter ion of higher valency.

As described above, in some embodiments, an electrochemical cell may comprise a second reactive species. The second reactive species may be a species comprising a labile halogen atom. In some embodiments, the labile halogen atom is a labile chlorine atom, a labile bromine atom, a labile iodine atom, and/or a labile fluorine atom. One example of a species comprising a labile chlorine atom is chloroethylene carbonate.

In some embodiments, the labile halogen atom is a labile fluorine atom. Non-limiting examples of suitable species comprising labile fluorine atoms include PF₆⁻, fluorinated ethylene carbonates (e.g., fluoro(ethylene carbonate), difluoro(ethylene carbonate)), fluorinated (oxalato)borate anions (e.g., a difluoro(oxalato)borate anion), and fluorinated (sulfonyl)imide anions (e.g., a bis(fluorosulfonyl)imide anion, a bis(trifluoromethane sulfonyl)imide anion).

It should be understood that some electrochemical cells may comprise two or more species comprising labile halogen atoms. In some such embodiments, the labile halogen atoms may be different (e.g., a species comprising a labile fluorine atom and a species comprising a labile chlorine atom) or the same (e.g., two or more different species comprising labile fluorine atoms). For instance, an electrochemical cell may comprise both PF₆⁻ and fluoro(ethylene carbonate).

When an electrochemical cell comprises a species comprising a labile halogen atom that is an ion, the electrochemical cell may further comprise one or more counter ions. In some embodiments, the counter ion is a monovalent counter ion. For instance, in some embodiments, the counter ion(s) comprises one or more alkali metal cations, such as Li⁺, Na⁺, K⁺, Rb⁺, Fr⁺ and/or Cs⁺. In some embodiments, the counter ion is a multivalent counter ion, such as a bivalent counter ion, a trivalent counter ion, or a counter ion of higher valency.

When present, a second reactive species (e.g., a species comprising a labile halogen atom) may make up a variety of suitable amounts of an electrochemical cell. Although the second reactive species may be present in portions of the electrochemical cell other than the electrolyte (in addition to or instead of being present in the electrolyte), it may be convenient to describe the amount of the second reactive species with reference to the amount of the electrolyte. Therefore, the wt % ranges listed below are with respect to the total weight of the electrolyte, including any second reactive species present therein and any counter ions therein. Additionally, it should be understood that the ranges listed below may refer to any of the following: (1) the total amount of a particular second reactive species and any counter ion(s) in the electrochemical cell as a whole; (2) the amount of a particular second reactive species and any counter ion(s) in the electrolyte (with further amounts of the second reactive species, or not); (3) the amount of all second reactive species and any counter ions in the electrochemical cell as a whole; and (4) the amount of all second reactive species and any counter ions in the electrolyte (with further amounts of the second reactive species in other locations in the electrochemical cell, or not).

In some embodiments, an electrochemical cell comprises a second reactive species (e.g., a species comprising a labile halogen atom) and any counter ion(s) thereof in an amount of greater than or equal to 5 wt %, greater than or equal to 7 wt %, greater than or equal to 10 wt %, greater than or equal to 15 wt %, greater than or equal to 20 wt %, or greater than or equal to 25 wt %. In some embodiments, an electrochemical cell comprises a second reactive species (e.g., a species comprising a labile halogen atom) and any counter ion(s) thereof in an amount of less than or equal to 50 wt %, less than or equal to 45 wt %, less than or equal to 40 wt %, less than or equal to 35 wt %, or less than or equal to 30 wt %. Combinations of these ranges are also possible (e.g., greater than or equal to 5 wt % and less than or equal to 50 wt % or greater than or equal to 10 wt % and less than or equal to 30 wt %).

As described above, in some embodiments, an electrochemical cell described herein comprises a layer (e.g., a protective layer). As also described above, the layer (e.g., protective layer) may comprise a first reactive species (i.e., a species comprising a conjugated, negatively-charged ring including a nitrogen atom) and/or a reaction product thereof (e.g., a reaction product between a metal (e.g., lithium metal and/or a transition metal) and the first reactive species; a reaction product of a first reactive species (i.e., a species comprising a conjugated, negatively-charged ring including a nitrogen atom) and a second reactive species (e.g., a species comprising a labile halogen atom); and/or a reaction product of a metal (e.g., lithium metal and/or a transition metal), a first reactive species, and a second reactive species (e.g., a reaction product of a metal with a reaction product of the first reactive species and the second reactive species)). In some embodiments, the layer (e.g., protective layer) comprises further species such as those found in typical SEIs (e.g., reaction products of the electroactive material with one or more electrolyte components).

In some embodiments, the layer (e.g., protective layer) comprises various elements. In some embodiments, the identity of these elements and/or the amounts of these elements may be determined using Energy Dispersive X-ray Spectra (EDS). In some embodiments, the layer (e.g., protective layer) comprises nitrogen.

In embodiments where the layer comprises nitrogen, the layer may comprise any suitable amount of nitrogen. For example, in some embodiments, the layer (e.g., on the cathode and/or anode) comprises greater than or equal to 0.1 atomic %, greater than or equal to 0.25 atomic %, greater than or equal to 0.5 atomic %, greater than or equal to 0.75 atomic %, greater than or equal to 1 atomic %, greater than or equal to 1.25 atomic %, greater than or equal to 1.5 atomic %, greater than or equal to 1.75 atomic %, greater than or equal to 2 atomic %, greater than or equal to 2.25 atomic %, greater than or equal to 2.5 atomic %, greater than or equal to 2.75 atomic %, greater than or equal to 3 atomic %, greater than or equal to 4 atomic %, or greater than or equal to 5 atomic % nitrogen. In some embodiments, the layer (e.g., on the cathode and/or anode) comprises less than or equal to 10 atomic %, less than or equal to 9 atomic %, less than or equal to 8 atomic %, less than or equal to 7 atomic %, less than or equal to 6 atomic %, less than or equal to 5 atomic %, less than or equal to 4.5 atomic %, less than or equal to 4 atomic %, less than or equal to 3.5 atomic %, less than or equal to 3 atomic %, less than or equal to 2.5 atomic %, less than or equal to 2 atomic %, or less than or equal to 1.5 atomic % nitrogen. Combinations of these ranges are also possible (e.g., greater than or equal to 0.1 atomic % and less than or equal to 10 atomic %, greater than or equal to 0.1 atomic % and less than or equal to 5 atomic %, greater than or equal to 0.5 atomic % and less than or equal to 3 atomic %, greater than or equal to 1 atomic % and less than or equal to 5 atomic %, or greater than or equal to 0.5 atomic % and less than or equal to 2 atomic %). Without wishing to be bound by theory, it is believed that the presence of nitrogen in the layer demonstrates that the layer comprises the first reactive species and/or a reaction product thereof.

In some embodiments, the layer (e.g., on the cathode and/or anode) comprises more of an element (e.g., nitrogen) than a layer and/or a surface of an electrode in an electrochemical cell where the electrolyte does not comprise the first reactive species, all other factors being equal. For example, in some embodiments, the layer (e.g., on the cathode and/or anode) comprises greater than or equal to 0.1 atomic %, greater than or equal to 0.25 atomic %, greater than or equal to 0.5 atomic %, greater than or equal to 0.75 atomic %, greater than or equal to 1 atomic %, greater than or equal to 1.25 atomic %, greater than or equal to 1.5 atomic %, greater than or equal to 1.75 atomic %, greater than or equal to 2 atomic %, greater than or equal to 2.25 atomic %, greater than or equal to 2.5 atomic %, greater than or equal to 2.75 atomic %, greater than or equal to 3 atomic %, greater than or equal to 4 atomic %, or greater than or equal to 5 atomic % nitrogen more than a layer and/or a surface of an electrode in an electrochemical cell where the electrolyte does not comprise the first reactive species, all other factors being equal. In some embodiments, the layer (e.g., on the cathode and/or anode) comprises less than or equal to 10 atomic %, less than or equal to 9 atomic %, less than or equal to 8 atomic %, less than or equal to 7 atomic %, less than or equal to 6 atomic %, less than or equal to 5 atomic %, less than or equal to 4.5 atomic %, less than or equal to 4 atomic %, less than or equal to 3.5 atomic %, less than or equal to 3 atomic %, less than or equal to 2.5 atomic %, less than or equal to 2 atomic %, or less than or equal to 1.5 atomic % nitrogen more than a layer and/or a surface of an electrode in an electrochemical cell where the electrolyte does not comprise the first reactive species, all other factors being equal. Combinations of these ranges are also possible (e.g., greater than or equal to 0.1 atomic % and less than or equal to 10 atomic %, greater than or equal to 0.1 atomic % and less than or equal to 5 atomic %, greater than or equal to 0.5 atomic % and less than or equal to 3 atomic %, or greater than or equal to 0.5 atomic % and less than or equal to 2 atomic %) than a layer and/or a surface of an electrode in an electrochemical cell where the electrolyte does not comprise the first reactive species, all other factors being equal. For example, if a layer on a cathode described herein comprises 3 atomic % nitrogen and a surface of a cathode in an electrochemical cell where the electrolyte does not comprise a first reactive species, all other factors being equal, comprises 1 atomic % nitrogen, then the former has 2 atomic % more nitrogen than the latter.

In some embodiments, a protective layer comprises a plurality of particles (e.g., deposited by aerosol deposition). The plurality of particles may be at least partially fused together and/or may have a structure indicative of particles deposited by aerosol deposition. Non-limiting examples of suitable types of fused particles and suitable methods of aerosol deposition include those described in U.S. Pat. Pub. No. 2016/0344067, U.S. Pat. No. 9,825,328, U.S. Pat. Pub. No. 2017/0338475, and U.S. Pat. Pub. No. 2018/0351148, each of which are incorporated herein by reference in their entirety and for all purposes. The plurality of particles that are at least partially fused together and/or that have a structure indicative of particles deposited by aerosol deposition may extend throughout the protective layer or through only a portion thereof. When the plurality of particles that are at least partially fused together and/or that have a structure indicative of particles deposited by aerosol deposition extend throughout the protective layer, the protective layer may be relatively uniform or may vary spatially (e.g., one or more other components of the protective layer, such as a first reactive species and/or a reaction product thereof described elsewhere herein, may not extend fully therethrough). When the plurality of particles that are at least partially fused together and/or that have a structure indicative of particles deposited by aerosol deposition extend only through a portion of the protective layer, they may form a discrete sublayer separate from one or more other sublayers of the protective layer or may interpenetrate with one or more other sublayers. Other morphologies are also possible.

For instance, a plurality of particles that are at least partially fused together and/or that have a structure indicative of particles deposited by aerosol deposition may form a relatively uniform layer together with one or more of the components described elsewhere herein (e.g., a first reactive species and/or a reaction product thereof, such as a reaction product of this species with a metal (e.g., lithium metal and/or a transition metal), a reaction product of this species with a second reactive species, and/or a reaction product of a metal (e.g., lithium metal and/or a transition metal), first reactive species, and second reactive species (e.g., a reaction product of a metal with a reaction product of a first reactive species and second reactive species)). In some such embodiments, the plurality of particles that are at least partially fused together and/or that have a structure indicative of particles deposited by aerosol deposition may, together with this component(s), form an interpenetrating structure. The interpenetrating structure may be a three-dimensional structure and/or may span the thickness of the protective layer.

In some embodiments, a protective layer comprises a first sublayer comprising a plurality of particles that are at least partially fused together and/or that have a structure indicative of particles deposited by aerosol deposition, and a second sublayer. The second sublayer may have one or more features described elsewhere herein with respect to protective layers as a whole. By way of example, the second sublayer may comprise a first reactive species and/or a reaction product thereof described elsewhere herein (e.g., a reaction product of a first reactive species with a metal (e.g., lithium metal and/or a transition metal), a reaction product of this species with a second reactive species, and/or a reaction product between a metal (e.g., lithium metal and/or a transition metal), a first reactive species, and a second reactive species (e.g., a reaction product with a metal (e.g., lithium metal and/or a transition metal) and a reaction product of the first reactive species and the second reactive species)). When a protective layer comprises two or more sublayers, the sublayers may be positioned with respect to each other in a variety of suitable manners. For instance, a protective layer may comprise a sublayer comprising a plurality of particles that are at least partially fused together and/or that have a structure indicative of particles deposited by aerosol deposition that is directly adjacent to an electrode (e.g., a first electrode comprising lithium metal or a second electrode comprising a transition metal) or may comprise a sublayer comprising a plurality of particles that are at least partially fused together and/or that have a structure indicative of particles deposited by aerosol deposition that is separated from an electrode (e.g., first electrode) by one or more intervening layers (e.g., intervening layers having one or more features described elsewhere herein with respect to protective layers as a whole). In some embodiments, a sublayer comprising a plurality of particles that are at least partially fused together and/or that have a structure indicative of particles deposited by aerosol deposition is the outermost sublayer of a multilayer protective layer.

A plurality of particles that are at least partially fused together and/or that have a structure indicative of particles deposited by aerosol deposition may be formed by a variety of suitable methods. One such method comprises depositing the particles onto an electrode (and/or any layer(s) disposed thereon) by aerosol deposition. The other component(s) of the protective layer may form upon exposure of the electrode to the relevant species (e.g., to a species comprising a conjugated, negatively-charged ring, to a species comprising a labile halogen atom), such as during electrochemical cell assembly and/or cycling. Other methods are also possible.

As described above, a protective layer may comprise a layer and/or sublayer comprising a plurality of particles at least partially fused together. The terms “fuse” and “fused” (and “fusion”) are given their typical meaning in the art and generally refers to the physical joining of two or more objects (e.g., particles) such that they form a single object. For example, in some cases, the volume occupied by a single particle (e.g., the entire volume within the outer surface of the particle) prior to fusion is substantially equal to half the volume occupied by two fused particles. Those skilled in the art would understand that the terms “fuse,” “fused,” and “fusion” do not refer to particles that simply contact one another at one or more surfaces, but particles wherein at least a portion of the original surface of each individual particle can no longer be discerned from the other particle. In some embodiments, a fused particle (e.g., a fused particle having the equivalent volume of the particle prior to fusion) may have a minimum cross-sectional dimension of less than 1 micron. For example, the plurality of particles after being fused may have an average minimum cross-sectional dimension of less than 1 micron, less than 0.75 microns, less than 0.5 microns, less than 0.2 microns, or less than 0.1 microns. In some embodiments, the plurality of particles after being fused have an average minimum cross-sectional dimension of greater than or equal to 0.05 microns, greater than or equal to 0.1 microns, greater than or equal to 0.2 microns, greater than or equal to 0.5 microns, or greater than or equal to 0.75 microns. Combinations of the above-referenced ranges are also possible (e.g., less than 1 micron and greater than or equal to 0.05 microns). Other ranges are also possible.

In some cases, a plurality of particles is fused such that at least a portion of the plurality of particles form a continuous pathway across the protective layer and/or sublayer thereof (e.g., between a first surface of the protective layer and a second, opposing, surface of the protective layer; between a first surface of the sublayer and a second, opposing, surface of the sublayer). A continuous pathway may include, for example, an ionically-conductive pathway from a first surface to a second, opposing surface of the protective layer and/or sublayer thereof in which there are substantially no gaps, breakages, or discontinuities in the pathway. While fused particles across a layer may form a continuous pathway, a pathway including packed, unfused particles may have gaps or discontinuities between the particles that would not render the pathway continuous. Such gaps and/or discontinuities may be filled (completely or partially) by another component of the protective layer and/or sublayer thereof, such as a first reactive species and/or a reaction product thereof described elsewhere herein (e.g., a reaction product of a first reactive species with a metal (e.g., lithium metal and/or a transition metal), a reaction product of this species with a second reactive species, and/or a reaction product between a metal (e.g., lithium metal and/or a transition metal), a first reactive species, and a second reactive species (e.g., a reaction product with a metal (e.g., lithium metal and/or a transition metal) and a reaction product of the first reactive species and the second reactive species)).

In some embodiments, a plurality of particles at least partially fused together forms a plurality of such continuous pathways across the protective layer and/or sublayer thereof. In some embodiments, at least 10 vol %, at least 30 vol %, at least 50 vol %, or at least 70 vol % of the protective layer and/or sublayer thereof comprises one or more continuous pathways comprising fused particles (e.g., which may comprise an ionically conductive material). In some embodiments, less than or equal to 100 vol %, less than or equal to 90 vol %, less than or equal to 70 vol %, less than or equal to 50 vol %, less than or equal to 30 vol %, less than or equal to 10 vol %, or less than or equal to 5 vol % of the protective layer and/or sublayer thereof comprises one or more continuous pathways comprising fused particles. Combinations of the above-referenced ranges are also possible (e.g., at least 10 vol % and less than or equal to 100 vol %). In some cases, 100 vol % of a sublayer of a protective layer comprises one or more continuous pathways comprising fused particles. That is to say, in some embodiments, a sublayer of the protective layer consists essentially of fused particles (e.g., the second layer comprises substantially no unfused particles). In other embodiments, the protective layer lacks unfused particles and/or is substantially free from unfused particles.

Those skilled in the art would be capable of selecting suitable methods for determining if particles are fused including, for example, performing Confocal Raman Microscopy (CRM). CRM may be used to determine the percentage of fused areas within a protective layer and/or sublayer thereof. For instance, in some aspects the fused areas may be less crystalline (more amorphous) compared to the unfused areas (e.g., particles) within the protective layer and/or sublayer thereof, and may provide different Raman characteristic spectral bands than those of the unfused areas. In some embodiments, the fused areas may be amorphous and the unfused areas (e.g., particles) within the layer may be crystalline. Crystalline and amorphous areas may have peaks at the same/similar wavelengths, while amorphous peaks may be broader/less intense than those of crystalline areas. In some instances, the unfused areas may include spectral bands substantially similar to the spectral bands of the bulk particles prior to formation of the layer (the bulk spectrum). For example, an unfused area may include peaks at the same or similar wavelengths and having a similar area under the peak (integrated signal) as the peaks within the spectral bands of the particles prior to formation of the layer. An unfused area may have, for instance, an integrated signal (area under the peak) for the largest peak (the peak having the largest integrated signal) in the spectrum that may be, e.g., within at least 70%, at least 75%, at least 80%, at least 85%, at least 90%, at least 95%, or at least 97% of the value of the integrated signal for the corresponding largest peak of the bulk spectrum. By contrast, the fused areas may include spectral bands different from (e.g., peaks at the same or similar wavelengths but having a substantially different/lower integrated signal than) the spectral bands of the particles prior to formation of the layer. A fused area may have, for instance, an integrated signal (area under the peak) for the largest peak (the peak having the largest integrated signal) in the spectrum that may be, e.g., less than 50%, less than 60%, less than 70%, less than 75%, less than 80%, less than 85%, less than 90%, less than 95%, or less than 97% of the value of the integrated signal for the corresponding largest peak of the bulk spectrum.

In some embodiments, two dimensional and/or three dimensional mapping of CRM may be used to determine the percentage of fused areas in a protective layer and/or sublayer thereof (e.g., the percentage of area, within a minimum cross-sectional area, having an integrated signal for the largest peak of the spectrum that differs from that for the particles prior to formation of the layer, as described above).

As described above, some methods relate to forming a portion of a protective layer and/or a sublayer of a protective layer by an aerosol deposition process. Aerosol deposition processes generally comprise depositing (e.g., spraying) particles (e.g., inorganic particles, polymeric particles) at a relatively high velocity on a surface. Aerosol deposition, as described herein, generally results in the collision and/or elastic deformation of at least some of the plurality of particles. In some aspects, aerosol deposition can be carried out under conditions (e.g., using a velocity) sufficient to cause fusion of at least some of the plurality of particles to at least another portion of the plurality of particles. For example, in some embodiments, a plurality of particles is deposited on an electrode (and/or any sublayer(s) disposed thereon) at a relatively high velocity such that at least a portion of the plurality of particles fuse (e.g., forming the portion and/or sublayer of the protective layer). The velocity required for particle fusion may depend on factors such as the material composition of the particles, the size of the particles, the Young's elastic modulus of the particles, and/or the yield strength of the particles or material forming the particles.

In some embodiments, a plurality of particles is deposited at a velocity sufficient to cause fusion of at least some of the particles therein. It should be appreciated, however, that in some aspects, the particles are deposited at a velocity such that at least some of the particles are not fused. In some aspects, the velocity of the particles is at least 150 m/s, at least 200 m/s, at least 300 m/s, at least 400 m/s, or at least 500 m/s, at least 600 m/s, at least 800 m/s, at least 1000 m/s, or at least 1500 m/s. In some embodiments, the velocity is less than or equal to 2000 m/s, less than or equal to 1500 m/s, less than or equal to 1000 m/s, less than or equal to 800 m/s, less than or equal to 600 m/s, less than or equal to 500 m/s, less than or equal to 400 m/s, less than or equal to 300 m/s, or less than or equal to 200 m/s. Combinations of the above-referenced ranges are also possible (e.g., at least 150 m/s and less than or equal to 2000 m/s, at least 150 m/s and less than or equal to 600 m/s, at least 200 m/s and less than or equal to 500 m/s, at least 200 m/s and less than or equal to 400 m/s, or at least 500 m/s and less than or equal to 2000 m/s). Other velocities are also possible. In some embodiments in which more than one particle type is included in a protective layer and/or sublayer thereof, each particle type may be deposited at a velocity in one or more of the above-referenced ranges.

In some embodiments, a plurality of particles to be at least partially fused is deposited by a method that comprises spraying the particles (e.g., via aerosol deposition) on the surface of an electrode (and/or any sublayer(s) disposed thereon) by pressurizing a carrier gas with the particles. In some embodiments, the pressure of the carrier gas is at least 5 psi, at least 10 psi, at least 20 psi, at least 50 psi, at least 90 psi, at least 100 psi, at least 150 psi, at least 200 psi, at least 250 psi, or at least 300 psi. In some embodiments, the pressure of the carrier gas is less than or equal to 350 psi, less than or equal to 300 psi, less than or equal to 250 psi, less than or equal to 200 psi, less than or equal to 150 psi, less than or equal to 100 psi, less than or equal to 90 psi, less than or equal to 50 psi, less than or equal to 20 psi, or less than or equal to 10 psi. Combinations of the above-referenced ranges are also possible (e.g., at least 5 psi and less than or equal to 350 psi). Other ranges are also possible and those skilled in the art would be capable of selecting the pressure of the carrier gas based upon the teachings of this specification. For example, in some embodiments, the pressure of the carrier gas is such that the velocity of the particles deposited on the electroactive material (and/or any sublayer(s) disposed thereon) is sufficient to fuse at least some of the particles to one another.

In some aspects, a carrier gas (e.g., the carrier gas transporting a plurality of particles to be at least partially fused) is heated prior to deposition. In some aspects, the temperature of the carrier gas is at least 20° C., at least 25° C., at least 30° C., at least 50° C., at least 75° C., at least 100° C., at least 150° C., at least 200° C., at least 300° C., or at least 400° C. In some embodiments, the temperature of the carrier gas is less than or equal to 500° C., less than or equal to 400° C., less than or equal to 300° C., less than or equal to 200° C., less than or equal to 150° C., less than or equal to 100° C., less than or equal to 75° C., less than or equal to 50° C., less than or equal to 30° C., or less than or equal to 20° C. Combinations of the above-referenced ranges are also possible (e.g., at least 20° C. and less than or equal to 500° C.). Other ranges are also possible.

In some embodiments, a plurality of particles to be at least partially fused are deposited under a vacuum environment. For example, the particles may be deposited on the surface of an electrode (and/or any sublayer(s) disposed thereon) in a container in which vacuum is applied to the container (e.g., to remove atmospheric resistance to particle flow, to permit high velocity of the particles, and/or to remove contaminants). In some embodiments, the vacuum pressure within the container is at least 0.5 mTorr, at least 1 mTorr, at least 2 mTorr, at least 5 mTorr, at least 10 mTorr, at least 20 mTorr, or at least 50 mTorr. In some embodiments, the vacuum pressure within the container is less than or equal to 100 mTorr, less than or equal to 50 mTorr, less than or equal to 20 mTorr, less than or equal to 10 mTorr, less than or equal to 5 mTorr, less than or equal to 2 mTorr, or less than or equal to 1 mTorr. Combinations of the above-referenced ranges are also possible (e.g., at least 0.5 mTorr and less than or equal to 100 mTorr). Other ranges are also possible.

In some embodiments, a process described herein for forming a protective layer and/or a sublayer thereof can be carried out such that the bulk properties of the precursor materials (e.g., particles) are maintained in the resulting layer (e.g., crystallinity, ion-conductivity).

In some embodiments, a plurality of particles that are at least partially fused together and/or that have a structure indicative of particles deposited by aerosol deposition comprises an inorganic material. For instance, a plurality of particles that are at least partially fused together and/or that have a structure indicative of particles deposited by aerosol deposition may be formed of an inorganic material. In some embodiments, a plurality of particles that are at least partially fused together and/or that have a structure indicative of particles deposited by aerosol deposition comprise two or more types of inorganic materials. The inorganic material(s) may comprise a ceramic material (e.g., a glass, a glassy-ceramic material). The inorganic material(s) may be crystalline, amorphous, or partially crystalline and partially amorphous.

In some embodiments, a plurality of particles that are at least partially fused together and/or that have a structure indicative of particles deposited by aerosol deposition comprises LiₓMP_{y}S_{z}. For such inorganic materials, x, y, and z may be integers (e.g., integers less than 32) and/or M may comprise Sn, Ge, and/or Si. By way of example, the inorganic material may comprise Li₂₂SiP₂S₁₈, Li₂₄MP₂S₁₉ (e.g., Li₂₄SiP₂S₁₉), LiMP₂S₁₂ (e.g., where M=Sn, Ge, Si), and/or LiSiPS. Even further examples of suitable inorganic materials include garnets, sulfides, phosphates, perovskites, anti-perovskites, other ion conductive inorganic materials, and/or mixtures thereof. When LiₓMP_{y}S_{z} particles are employed in a protective layer and/or sublayer thereof, they may be formed, for example, by using raw components Li₂S, SiS₂ and P₂S₅ (or alternatively Li₂S, Si, S and P₂S₅).

In some embodiments, a plurality of particles that are at least partially fused together and/or that have a structure indicative of particles deposited by aerosol deposition comprises an oxide, nitride, and/or oxynitride of lithium, aluminum, silicon, zinc, tin, vanadium, zirconium, magnesium, and/or indium, and/or an alloy thereof. Non-limiting examples of suitable oxides include Li₂O, LiO, LiO₂, LiRO₂ where R is a rare earth metal (e.g., lithium lanthanum oxides), lithium titanium oxides, Al₂O₃, ZrO₂, SiO₂, CeO₂, and Al₂TiO₅. Further examples of suitable materials that may be employed in a plurality of particles that are at least partially fused together and/or that have a structure indicative of particles deposited by aerosol deposition include lithium nitrates (e.g., LiNO₃), lithium silicates, lithium borates (e.g., lithium bis(oxalato)borate, lithium difluoro(oxalato)borate), lithium aluminates, lithium oxalates, lithium phosphates (e.g., LiPO₃, Li₃PO₄), lithium phosphorus oxynitrides, lithium silicosulfides, lithium germanosulfides, lithium fluorides (e.g., LiF, LiBF₄, LiAlF₄, LiPF₆, LiAsF₆, LiSbF₆, Li₂SiF₆, LiSO₃F, LiN(SO₂F)₂, LiN(SO₂CF₃)₂), lithium borosulfides, lithium aluminosulfides, lithium phosphosulfides, oxy-sulfides (e.g., lithium oxy-sulfides), and/or combinations thereof. In some embodiments, the plurality of particles comprises Li—Al—Ti—PO₄ (LATP).

As described above, in some embodiments, the electrochemical cell comprises an electrolyte. As also described above, the electrolyte may comprise a first reactive species (i.e., a species comprising a conjugated, negatively-charged ring including a nitrogen atom) and/or a second reactive species (e.g., a species comprising a labile halogen atom). The electrolyte may further comprise additional components, such as those described in greater detail below.

In some embodiments, an electrochemical cell includes an electrolyte (e.g., a liquid electrolyte). In some embodiments, the electrolyte (e.g., liquid electrolyte) comprises a solvent. In some embodiments, the electrolyte (e.g., liquid electrolyte) is a non-aqueous electrolyte. Suitable non-aqueous electrolytes may include organic electrolytes such as liquid electrolytes, gel polymer electrolytes, and solid polymer electrolytes. These electrolytes may optionally include one or more ionic electrolyte salts (e.g., to provide or enhance ionic conductivity). Examples of useful solvents (e.g., non-aqueous liquid electrolyte solvents) include, but are not limited to, non-aqueous organic solvents, such as, for example, N-methyl acetamide, acetonitrile, acetals, ketals, esters (e.g., esters of carbonic acid, sulfonic acid, an/or phosphoric acid), carbonates (e.g., dimethyl carbonate, diethyl carbonate, ethyl methyl carbonate, propylene carbonate, ethylene carbonate, fluoroethylene carbonate, difluoroethylene carbonate), sulfones, sulfites, sulfolanes, suflonimidies (e.g., bis(trifluoromethane)sulfonimide lithium salt), ethers (e.g., aliphatic ethers, acyclic ethers, cyclic ethers), glymes, polyethers, phosphate esters (e.g., hexafluorophosphate), siloxanes, dioxolanes, N-alkylpyrrolidones, nitrate containing compounds, substituted forms of the foregoing, and blends thereof. Examples of acyclic ethers that may be used include, but are not limited to, diethyl ether, dipropyl ether, dibutyl ether, dimethoxymethane, trimethoxymethane, 1,2-dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents.

In some cases, mixtures of the solvents described herein may also be used. For example, in some embodiments, mixtures of solvents are selected from the group consisting of 1,3-dioxolane and dimethoxyethane, 1,3-dioxolane and diethyleneglycol dimethyl ether, 1,3-dioxolane and triethyleneglycol dimethyl ether, and 1,3-dioxolane and sulfolane. In some embodiments, the mixture of solvents comprises dimethyl carbonate and ethylene carbonate. In some embodiments, the mixture of solvents comprises ethylene carbonate and ethyl methyl carbonate. The weight ratio of the two solvents in the mixtures may range, in some cases, from about 5 wt %:95 wt % to 95 wt %:5 wt %. For example, in some embodiments the electrolyte comprises a 50 wt %:50 wt % mixture of dimethyl carbonate:ethylene carbonate. In some other embodiments, the electrolyte comprises a 30 wt %:70 wt % mixture of ethylene carbonate:ethyl methyl carbonate. An electrolyte may comprise a mixture of dimethyl carbonate:ethylene carbonate with a ratio of dimethyl carbonate:ethylene carbonate that is less than or equal to 50 wt %:50 wt % and greater than or equal to 30 wt %:70 wt %.

In some embodiments, an electrolyte may comprise a mixture of fluoroethylene carbonate and dimethyl carbonate. A weight ratio of fluoroethylene carbonate to dimethyl carbonate may be 20 wt %:80 wt % or 25 wt %:75 wt %. A weight ratio of fluoroethylene carbonate to dimethyl carbonate may be greater than or equal to 20 wt %:80 wt % and less than or equal to 25 wt %:75 wt %.

Non-limiting examples of suitable gel polymer electrolytes include polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, derivatives of the foregoing, copolymers of the foregoing, cross-linked and network structures of the foregoing, and blends of the foregoing.

Non-limiting examples of suitable solid polymer electrolytes include polyethers, polyethylene oxides, polypropylene oxides, polyimides, polyphosphazenes, polyacrylonitriles, polysiloxanes, derivatives of the foregoing, copolymers of the foregoing, cross-linked and network structures of the foregoing, and blends of the foregoing.

In some embodiments, an electrolyte is in the form of a layer having a particular thickness. An electrolyte layer may have a thickness of, for example, at least 1 micron, at least 5 microns, at least 10 microns, at least 15 microns, at least 20 microns, at least 25 microns, at least 30 microns, at least 40 microns, at least 50 microns, at least 70 microns, at least 100 microns, at least 200 microns, at least 500 microns, or at least 1 mm. In some embodiments, the thickness of the electrolyte layer is less than or equal to 1 mm, less than or equal to 500 microns, less than or equal to 200 microns, less than or equal to 100 microns, less than or equal to 70 microns, less than or equal to 50 microns, less than or equal to 40 microns, less than or equal to 30 microns, less than or equal to 20 microns, less than or equal to 10 microns, or less than or equal to 5 microns. Other values are also possible. Combinations of the above-noted ranges are also possible.

In some embodiments, the electrolyte comprises at least one salt (e.g., lithium salt). For example, in some cases, the at least one salt (e.g., lithium salt) comprises LiSCN, LiBr, LiI, LiSO₃CH₃, LiNO₃, LiPF₆, LiBF₄, LiB(Ph)₄, LiClO₄, LiAsF₆, Li₂SiF₆, LiSbF₆, LiAlCl₄, an oxalo(borate group) (e.g., lithium bis(oxalato)borate), lithium difluoro(oxalato)borate, a salt comprising a tris(oxalato)phosphate anion (e.g., lithium tris(oxalato)phosphate), LiCF₃SO₃, LiN(SO₂F)₂, LiN(SO₂CF₃)₂, LiC(CₙF₂ₙ₊₁SO₂)₃ wherein n is an integer in the range of from 1 to 20, and (CₙF₂ₙ₊₁FiSO₂)ₘXLi with n being an integer in the range of from 1 to 20, m being 1 when X is selected from oxygen or sulfur, m being 2 when X is selected from nitrogen or phosphorus, and m being 3 when X is selected from carbon or silicon.

When present, a lithium salt may be present in the electrolyte at a variety of suitable concentrations. In some embodiments, the lithium salt is present in the electrolyte at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, greater than or equal to 2 M, or greater than or equal to 5 M. The lithium salt may be present in the electrolyte at a concentration of less than or equal to 10 M, less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 10 M, or greater than or equal to 0.01 M and less than or equal to 5 M). Other ranges are also possible.

In some embodiments, an electrolyte may comprise LiPF₆ in an advantageous amount. In some embodiments, the electrolyte comprises LiPF₆ at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, or greater than or equal to 2 M. The electrolyte may comprise LiPF₆ at a concentration of less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 5 M). Other ranges are also possible.

In some embodiments, an electrolyte comprises a species with an oxalato(borate) group (e.g., LiBOB, lithium difluoro(oxalato)borate), and the total weight of the species with an (oxalato)borate group in the electrolyte may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In some embodiments, the total weight of the species with an (oxalato)borate group in the electrochemical cell is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater 18 wt %, greater than 20 wt %, greater than 22 wt %, greater than 25 wt %, or greater than 28 wt % versus the total weight of the electrolyte. Combinations of the above-referenced ranges are also possible (e.g., greater than 0.2 wt % and less than or equal to 30 wt %, greater than 0.2 wt % and less than or equal to 20 wt %, greater than 0.5 wt % and less than or equal to 20 wt %, greater than 1 wt % and less than or equal to 8 wt %, greater than 1 wt % and less than or equal to 6 wt %, greater than 4 wt % and less than or equal to 10 wt %, greater than 6 wt % and less than or equal to 15 wt %, or greater than 8 wt % and less than or equal to 20 wt %). Other ranges are also possible.

In some embodiments, an electrolyte comprises fluoroethylene carbonate. In some embodiments, the total weight of the fluoroethylene carbonate in the electrolyte may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In some embodiments, the total weight of the fluoroethylene carbonate in the electrolyte is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater than 18 wt %, greater than 20 wt %, greater than 22 wt %, greater than 25 wt %, or greater than 28 wt % versus the total weight of the electrolyte. Combinations of the above-referenced ranges are also possible (e.g., less than or equal to 0.2 wt % and greater than 30 wt %, less than or equal to 15 wt % and greater than 20 wt %, or less than or equal to 20 wt % and greater than 25 wt %). Other ranges are also possible.

In some embodiments, the wt % of one or more electrolyte components is measured prior to first use or first discharge of the electrochemical cell using known amounts of the various components. In other embodiments, the wt % is measured at a point in time during the cycle life of the cell. In some such embodiments, the cycling of an electrochemical cell may be stopped and the wt % of the relevant component in the electrolyte may be determined using, for example, gas chromatography-mass spectrometry. Other methods such as NMR, inductively coupled plasma mass spectrometry (ICP-MS), and elemental analysis can also be used.

In some embodiments, an electrolyte may comprise several species together that are particularly beneficial in combination. For instance, in some embodiments, the electrolyte comprises fluoroethylene carbonate, dimethyl carbonate, and LiPF₆. The weight ratio of fluoroethylene carbonate to dimethyl carbonate may be between 20 wt %:80 wt % and 25 wt %:75 wt % and the concentration of LiPF₆ in the electrolyte may be approximately 1 M (e.g., between 0.05 M and 2 M). The electrolyte may further comprise lithium bis(oxalato)borate (e.g., at a concentration between 0.1 wt % and 6 wt %, between 0.5 wt % and 6 wt %, or between 1 wt % and 6 wt % in the electrolyte), and/or lithium tris(oxalato)phosphate (e.g., at a concentration between 1 wt % and 6 wt % in the electrolyte).

As described above, in some embodiments, an electrochemical cell comprises a first electrode. The first electrode may be an anode and/or a negative electrode (e.g., an electrode at which oxidation occurs during discharging and reduction occurs during charging).

In some embodiments, the first electrode comprises an electroactive material comprising lithium (e.g., lithium metal). In some embodiments, a first electrode comprises an electroactive material in which lithium forms part of an alloy. Suitable lithium alloys can include alloys of lithium and aluminum, magnesium, silicium (silicon), indium, and/or tin. In some embodiments, a first electrode comprises an electroactive material that contains at least 50 wt % lithium. In some cases, the electroactive material contains at least 75 wt %, at least 90 wt %, at least 95 wt %, or at least 99 wt % lithium.

The electroactive material in a first electrode may take the form of a foil (e.g., lithium foil), lithium deposited (e.g., vacuum deposited) onto a conductive substrate (e.g., lithium deposited onto a conductive substrate, such as a released Cu/PVOH substrate), or may have another suitable structure. In some embodiments, the electroactive material in the first electrode forms one film or several films, which are optionally separated from each other. In some embodiments, the first electrode and/or electroactive material comprises a lithium intercalation compound (e.g., a compound that is capable of reversibly inserting lithium ions at lattice sites and/or interstitial sites), such as a lithium carbon anode.

In some embodiments, a surface of the electroactive material of the first electrode may be passivated. Without wishing to be bound by theory, electroactive material surfaces that are passivated are surfaces that have undergone a chemical reaction to form a layer that is less reactive (e.g., with an electrolyte) than material that is present in the bulk of the electroactive material. One method of passivating an electroactive material surface is to expose the electroactive material to a plasma comprising CO₂ and/or SO₂ to form a CO₂— and/or SO₂-induced layer. Some inventive methods and articles may comprise passivating an electroactive material by exposing it to CO₂ and/or SO₂, or an electroactive material with a surface that has been passivated by exposure to CO₂ and/or SO₂. Such exposure may form a porous passivation layer on the electroactive material (e.g., a CO₂— and/or SO₂-induced layer).

As described above, in some embodiments, an electrochemical cell described herein comprises a second electrode. The second electrode may be a cathode and/or a positive electrode (e.g., an electrode at which reduction occurs during discharging and oxidation occurs during charging).

In some embodiments, the second electrode comprises an electroactive material. A second electrode may comprise an electroactive material comprising a lithium intercalation compound (e.g., a compound that is capable of reversibly inserting lithium ions at lattice sites and/or interstitial sites). In some cases, the electroactive material comprises a lithium transition metal oxo compound (i.e., a lithium transition metal oxide or a lithium transition metal salt of an oxoacid). The electroactive material may be a layered oxide (e.g., a layered oxide that is also a lithium transition metal oxo compound). A layered oxide generally refers to an oxide having a lamellar structure (e.g., a plurality of sheets, or layers, stacked upon each other). Non-limiting examples of suitable layered oxides (e.g., lithium transition metal oxides) include lithium nickel manganese cobalt oxide, lithium nickel cobalt aluminum oxide, lithium cobalt oxide (LiCoO₂), lithium nickel oxide (LiNiO₂), and lithium manganese oxide (LiMnO₂).

In some embodiments, a second electrode comprises a layered oxide that is lithium nickel manganese cobalt oxide (LiNiₓMn_{y}Co_{z}O₂, also referred to as “NMC” or “NCM,” such as NCM622, NCM721, and/or NCM811). In some such embodiments, the sum of x, y, and z is 1. For example, a non-limiting example of a suitable NMC compound is LiNi_{1/3}Mn_{1/3}Co_{1/3}O₂. Other non-limiting examples of suitable NMC compounds include LiNi_{3/5}Mn_{1/5}Co_{1/5}O₂ and LiNi_{7/10}Mn_{1/10}Co_{1/5} O₂.

In some embodiments, a second electrode comprises a layered oxide that is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂.

In some embodiments, the second electrode and/or the electroactive material comprises a transition metal. In some embodiments, the transition metal comprises Co, Ni, Mn, Fe, Cr, V, Cu, Zr, Nb, Mo, Ag, and/or lanthanide metals. In some embodiments, the transition metal comprises a transition metal oxide (e.g., a lithium transition metal oxide, as discussed above). For example, in some embodiments, the second electrode and/or the electroactive material comprises a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄.

In some embodiments, the electroactive material comprises a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In some cases, the electroactive material comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the electroactive material in a second electrode comprises a conversion compound. For instance, the electroactive material may be a lithium conversion material. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs). In some cases, the electroactive material may comprise a material that is doped with one or more dopants to alter the electrical properties (e.g., electrical conductivity) of the electroactive material. Non-limiting examples of suitable dopants include aluminum, niobium, silver, and zirconium.

In some embodiments, the electroactive material in a second electrode can comprise sulfur. In some embodiments, an electrode that is a cathode can comprise electroactive sulfur-containing materials. “Electroactive sulfur-containing materials,” as used herein, refers to electroactive materials which comprise the element sulfur in any form, wherein the electrochemical activity involves the oxidation or reduction of sulfur atoms or moieties. As an example, the electroactive sulfur-containing material may comprise elemental sulfur (e.g., S₈). In some embodiments, the electroactive sulfur-containing material comprises a mixture of elemental sulfur and a sulfur-containing polymer. Thus, suitable electroactive sulfur-containing materials may include, but are not limited to, elemental sulfur, sulfides or polysulfides (e.g., of alkali metals) which may be organic or inorganic, and organic materials comprising sulfur atoms and carbon atoms, which may or may not be polymeric. Suitable organic materials include, but are not limited to, those further comprising heteroatoms, conductive polymer segments, composites, and conductive polymers. In some embodiments, an electroactive sulfur-containing material within a second electrode (e.g., a cathode) comprises at least 40 wt % sulfur. In some cases, the electroactive sulfur-containing material comprises at least 50 wt %, at least 75 wt %, or at least 90 wt % sulfur.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al., and PCT Publication No. WO 99/33130, which are incorporated herein by reference in their entirety and for all purposes. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al., which are incorporated herein by reference in their entirety and for all purposes. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al., which are incorporated herein by reference in their entirety and for all purposes.

In some embodiments, the second electrode and/or electroactive material comprises a combination of any of the electroactive materials described for the second electrode (e.g., NCM811 and NCM721).

In some embodiments, a layer (e.g., a protective layer, such as an SEI) is disposed on the second electrode. In some embodiments, the layer comprises a first reactive species and/or a reaction product thereof. For example, in some embodiments, the layer comprises a reaction product between a component of the electroactive material (e.g., a transition metal) and the first reactive species (i.e., a species comprising a conjugated, negatively-charged ring comprising a nitrogen atom). As another example, in some embodiments, the layer comprises a reaction product between the first reactive species (i.e., a species comprising a conjugated, negatively-charged ring comprising a nitrogen atom) and a second reactive species (e.g., a species comprising the labile halogen atom). As yet another example, in some embodiments, the layer comprises a reaction product between a component of the electroactive material (e.g., a transition metal), the first reactive species (i.e., a species comprising a conjugated, negatively-charged ring comprising a nitrogen atom), and a second reactive species (e.g., a species comprising the labile halogen atom) (e.g., a reaction product between the electroactive material (e.g., a transition metal) and a reaction product of the first reactive species and the second reactive species)).

Some methods described herein relate to depositing the first reactive species/and or a reaction product thereof on the second electrode (e.g., to form a layer). Such methods can be understood in relation to FIGS. 1D-1G. In some embodiments, the method comprises placing a volume of an electrolyte in an electrochemical cell. In some embodiments, the electrolyte comprises a first reactive species (i.e., a species comprising a conjugated, negatively-charged ring comprising a nitrogen atom) and/or a second reactive species (e.g., a species comprising a labile halogen atom). For example, in some embodiments, the method comprises placing electrolyte 300 in electrochemical cell 1000, which comprises first electrode 100 and second electrode 200, as shown in FIG. 1D, wherein electrolyte 300 comprises first reactive species 12 and/or second reactive species 22. In some such embodiments, the second electrode (e.g., second electrode 200 in FIG. 1D) comprises a transition metal. In some such embodiments, the first reactive species reacts with the transition metal. In some embodiments, the method comprises forming a protective layer on the second electrode. The protective layer may, in some embodiments, comprise the first reactive species and/or a reaction product thereof (e.g., a reaction product between the transition metal and the first reactive species). For example, in some embodiments, the method further comprises forming layer 404 on second electrode 200, as shown in FIG. 1G, wherein layer 404 comprises a reaction product between the transition metal (e.g., in second electrode 200) and first reactive species 12. In some embodiments, the method comprises forming layer 404 on second electrode 200, as shown in FIG. 1G, wherein layer 404 comprises a reaction product between first reactive species 12 and second reactive species 22. In some embodiments, the method comprises forming layer 404 on second electrode 200, as shown in FIG. 1G, wherein layer 404 comprises a reaction product between the transition metal and the reaction product between first reactive species 12 and second reactive species 22.

As described herein, in some embodiments, an electrochemical cell includes a separator. In some embodiments, the separator comprises a polymeric material (e.g., polymeric material that does or does not swell upon exposure to electrolyte) (e.g., monolayer or multilayer), glass, ceramic, and/or combinations thereof (e.g., ceramic/polymer composite or ceramic coated polymer). In some embodiments, the separator is located between an electrolyte and an electrode (e.g., between the electrolyte and a first electrode, between the electrolyte and a second electrode) and/or between two electrodes (e.g., between a first electrode and a second electrode).

The separator can be configured to inhibit (e.g., prevent) physical contact between two electrodes (e.g., between a first electrode and a second electrode), which could result in short circuiting of the electrochemical cell. The separator can be configured to be substantially electronically non-conductive, which can reduce the tendency of electric current to flow therethrough and thus reduce the possibility that a short circuit passes therethrough. In some embodiments, all or one or more portions of the separator can be formed of a material with a bulk electronic resistivity of at least 10⁴, at least 10⁵, at least 10¹⁰, at least 10¹⁵, or at least 10²⁰ Ohm-meters. The bulk electronic resistivity may be measured at room temperature (e.g., 25° C.).

In some embodiments, the separator can be ionically conductive, while in other embodiments, the separator is substantially ionically non-conductive. In some embodiments, the average ionic conductivity of the separator is at least 10⁻⁷ S/cm, at least 10⁻⁶ S/cm, at least 10⁻⁵ S/cm, at least 10⁻⁴ S/cm, at least 10⁻² S/cm, or at least 10⁻¹ S/cm. In some embodiments, the average ionic conductivity of the separator may be less than or equal to 1 S/cm, less than or equal to 10⁻¹ S/cm, less than or equal to 10⁻² S/cm, less than or equal to 10⁻³ S/cm, less than or equal to 10⁻⁴ S/cm, less than or equal to 10⁻⁵ S/cm, less than or equal to 10⁻⁶ S/cm, less than or equal to 10⁻⁷ S/cm, or less than or equal to 10⁻⁸ S/cm. Combinations of the above-referenced ranges are also possible (e.g., an average ionic conductivity of at least 10⁻⁸ S/cm and less than or equal to 10⁻¹ S/cm). Other values of ionic conductivity are also possible.

The average ionic conductivity of the separator can be determined by employing a conductivity bridge (i.e., an impedance measuring circuit) to measure the average resistivity of the separator at a series of increasing pressures until the average resistivity of the separator does not change as the pressure is increased. This value is considered to be the average resistivity of the separator, and its inverse is considered to be the average conductivity of the separator. The conductivity bridge may be operated at 1 kHz. The pressure may be applied to the separator in 500 kg/cm² increments by two copper cylinders positioned on opposite sides of the separator that are capable of applying a pressure to the separator of at least 3 tons/cm². The average ionic conductivity may be measured at room temperature (e.g., 25° C.).

In some embodiments, the separator can be a solid. The separator may be sufficiently porous such that it allows an electrolyte solvent to pass through it. In some embodiments, the separator does not substantially include a solvent (e.g., it may be unlike a gel that comprises solvent throughout its bulk), except for solvent that may pass through or reside in the pores of the separator. In other embodiments, a separator may be in the form of a gel.

A separator can comprise a variety of materials. The separator may comprise one or more polymers (e.g., the separator may be polymeric, the separator may be formed of one or more polymers), and/or may comprise an inorganic material (e.g., the separator may be inorganic, the separator may be formed of one or more inorganic materials).

Examples of suitable polymers that may be employed in separators include, but are not limited to, polyolefins (e.g., polyethylenes, poly(butene-1), poly(n-pentene-2), polypropylene, polytetrafluoroethylene); polyamines (e.g., poly(ethylene imine) and polypropylene imine (PPI)); polyamides (e.g., polyamide (Nylon), poly(e-caprolactam) (Nylon 6), poly(hexamethylene adipamide) (Nylon 66)); polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcyanoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(e-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

Non-limiting examples of suitable inorganic separator materials include glass fibers. For instance, in some embodiments, an electrochemical cell comprises a separator that is a glass fiber filter paper.

When present, the separator may be porous. In some embodiments, the pore size of the separator is less than or equal to 5 microns, less than or equal to 3 microns, less than or equal to 1 micron, less than or equal to 500 nm, less than or equal to 300 nm, less than or equal to 100 nm, or less than or equal to 50 nm. In some embodiments, the pore size of the separator is greater than or equal to 50 nm, greater than or equal to 100 nm, greater than or equal to 300 nm, greater than or equal to 500 nm, greater than or equal to 1 micron, or greater than or equal to 3 microns. Other values are also possible. Combinations of the above-noted ranges are also possible (e.g., less than or equal to 5 microns and greater than or equal to 50 nm, less than or equal to 300 nm and greater than or equal to 100 nm, less than or equal to 1 micron and greater than or equal to 300 nm, or less than or equal to 5 microns and greater than or equal to 500 nm).

In some embodiments, the separator is substantially non-porous. In other words, in some embodiments, the separator may lack pores, include a minimal number of pores, and/or not include pores in large portions thereof.

In some embodiments, an electrochemical cell described herein comprises at least one current collector. A current collector may be disposed on an electrode (e.g., a first electrode, a second electrode), and may provide electrons from the electrode to an external circuit (e.g., in the case of a current collector disposed on an anode or negative electrode) or may supply electrons to the electrode from an external circuit (e.g., in the case of a current collector disposed on a cathode or positive electrode). Non-limiting examples of suitable materials that may be employed in current collectors include metals (e.g., copper, nickel, aluminum, passivated metals), metallized polymers (e.g., metallized PET), electrically conductive polymers, and polymers comprising conductive particles dispersed therein.

Current collectors may be formed in a variety of manners. For instance, a current collector may be deposited onto an electrode by physical vapor deposition, chemical vapor deposition, electrochemical deposition, sputtering, doctor blading, flash evaporation, or any other appropriate deposition technique for the selected material. As another example, in some embodiments, a current collector is formed separately from an electrode and then bonded to the electrode (and/or to a component, such as a layer, thereof). It should be appreciated, however, that in some embodiments a current collector separate from an electrode (e.g., separate from a first electrode, separate from a second electrode) is not needed or present. This may be true when the electrode itself (and/or the electroactive material therein) is electrically conductive.

In some embodiments, one or more portions of an electrochemical cell described herein (e.g., an electrode, a protective layer) may be disposed on or deposited onto a support layer. A support layer may be a layer that supports the relevant portion of the electrochemical cell, and/or may be a layer onto which it is beneficial to deposit the relevant portion of the electrochemical cell. For example, in one set of embodiments, the support layer may be disposed on a layer such as a carrier substrate that is not designed to be incorporated into a final electrochemical cell and may be capable of releasing the relevant portion of the electrochemical cell from that layer. When the support layer is adjacent a carrier substrate, the support layer may be partially or entirely delaminated from the electroactive material or layer during subsequent steps in electrochemical cell formation, and/or it may be partially or entirely delaminated from the carrier substrate during subsequent steps in electrochemical cell formation.

As another example, the support layer may be disposed on a layer which may be incorporated into an electrochemical cell but onto which it may be challenging to deposit one or more portions of an electrochemical cell (e.g., an electrode, a protective layer). For instance, the support layer may be disposed on a separator or an additional support layer (e.g., an additional support layer on a separator). A support layer that is adjacent a separator may serve to prevent deposition of one or more portions of the relevant portion of the electrochemical cell into any pores present in the separator and/or may serve to prevent contact between the separator and the relevant portion of the electrochemical cell. In some embodiments, a support layer that is initially adjacent a carrier substrate or a separator may be incorporated into a final electrochemical cell.

In some such cases, such as when a support layer is incorporated into a final electrochemical cell, the support layer may be formed of a material that is stable in the electrolyte and does not substantially interfere with the structural integrity of the electrode. For example, the support layer may be formed of a polymer or gel electrolyte (e.g., it may comprise lithium ions and/or be conductive to lithium ions) and/or a polymer that may swell in a liquid electrolyte to form a polymer gel electrolyte. In certain embodiments, the support layer itself may function as a separator. In some embodiments, a support layer may be formed of a polymer that is soluble in an electrolyte present in an electrochemical cell in which the electrode comprising the composite protective layer is positioned (e.g., an aprotic electrolyte), and/or may be dissolved upon exposure to the electrolyte (e.g., upon exposure to the aprotic electrolyte).

Non-limiting examples of suitable structures for portions of electrochemical cells that include support layers include the following: optional carrier substrate/support layer/optional current collector/first electrode/optional protective layer/optional separator and optional carrier substrate/support layer/optional separator/protective layer/electrode/optional current collector. The layers described as optional in the preceding sentence may be present in the structure or may optionally be absent. When absent, the layers described as being positioned on either side of the optional layer may be positioned directly adjacent each other or may be positioned on opposite sides of a different layer. Similarly, it should be understood that the layers separated by slashes above may be directly adjacent each other or may be separated by one or more intervening layers.

In some embodiments, the support layer may be a release layer, such as the release layers described in U.S. Pat. Pub. No. 2014/272,565, U.S. Pat. Pub. No. 2014/272,597, and U.S. Pat. Pub. No. 2011/068,001, each of which are herein incorporated by reference in their entirety. In some embodiments, it may be preferred for the support layer to be a release layer comprising hydroxyl functional groups (e.g., comprising PVOH and/or EVAL) and having one of the structures described above.

In one set of embodiments, a support layer (e.g., a polymeric support layer, a release layer) is formed of a polymeric material. Specific examples of appropriate polymers include, but are not limited to, polyoxides, poly(alkyl oxides)/polyalkylene oxides (e.g., polyethylene oxide, polypropylene oxide, polybutylene oxide), polyvinyl alcohols, polyvinyl butyral, polyvinyl formal, vinyl acetate-vinyl alcohol copolymers, ethylene-vinyl alcohol copolymers, and vinyl alcohol-methyl methacrylate copolymers, polysiloxanes, and fluorinated polymers. The polymer may be in the form of, for example, a solid polymer (e.g., a solid polymer electrolyte), a glassy-state polymer, or a polymer gel.

Additional examples of polymeric materials include polysulfones, polyethersulfone, polyphenylsulfones (e.g., Ultrason® S 6010, S 3010 and S 2010, available from BASF), polyethersulfone-polyalkyleneoxide copolymers, polyphenylsulfone-polyalkyleneoxide copolymers, polysulfone-polyalkylene oxide copolymers, polyisobutylene (e.g., Oppanol® B10, B15, B30, B80, B150 and B200, available from BASF), polyisobutylene succinic anhydride (PIBSA), polyisobutylene-polyalkyleneoxide copolymers, polyamide 6 (e.g., Ultramid® B33, available from BASF) (e.g., extrusion of 2 μm polyamide layer on polyolefin carrier or solution casting of PA layer on polyolefin carrier substrate), polyvinylpyrrolidone, polyvinylpyrrolidone-polyvinylimidazole copolymers (e.g., Sokalan® HP56, available from BASF), polyvinylpyrrolidone-polyvinylactetate copolymers (e.g., Luviskol®, available from BASF), maleinimide-vinylether copolymers, polyacrylamides, fluorinated polyacrylates (optionally including surface reactive comonomers), polyethylene-polyvinylalcohol copolymers (e.g., Kuraray®, available from BASF), polyethylene-polyvinylacetate copolymers, polyvinylalcohol and polyvinylacetate copolymers, polyoxymethylene (e.g., extruded), polyvinylbutyral (e.g., Kuraray®, available from BASF), polyureas (e.g., branched), polymers based on photopolymerization of acrolein derivatives (CH2=CR—C(O)R), polysulfone-polyalkyleneoxide copolymers, polyvinylidene difluoride (e.g., Kynar® D155, available from BASF), and combinations thereof.

In one embodiment, a support layer comprises a polyethersulfone-polyalkylene oxide copolymer. In one particular embodiment, the polyethersulfone-polyalkylene oxide copolymer is a polyarylethersulfone-polyalkylene oxide copolymer (PPC) obtained by polycondensation of reaction mixture (RG) comprising the components: (A1) at least one aromatic dihalogen compound, (B1) at least one aromatic dihydroxyl compound, and (B2) at least one polyalkylene oxide having at least two hydroxyl groups. The reaction mixture may also include (C) at least one aprotic polar solvent and (D) at least one metal carbonate, where the reaction mixture (RG) does not comprise any substance which forms an azeotrope with water. The resulting copolymer may be a random copolymer or a block copolymer. For instance, the resulting copolymer may include blocks of A1-B1, and blocks of A1-B2. The resulting copolymer may, in some instances, include blocks of A1-B1-A1-B2.

Further examples of polymeric materials include polyimide (e.g., Kapton®) with a hexafluoropropylene (HFP) coating (e.g., available from Dupont); siliconized polyester films (e.g., a Mitsubishi polyester), metallized polyester films (e.g., available from Mitsubishi or Sion Power), polybenzimidazoles (PBI; e.g., low molecular weight PBI—available from Celanese), polybenzoxazoles (e.g., available from Foster-Miller, Toyobo), ethylene-acrylic acid copolymers (e.g., Poligen®, available from BASF), acrylate based polymers (e.g., Acronal®, available from BASF), (charged) polyvinylpyrrolidone-polyvinylimidazole copolymers (e.g., Sokalane® HP56, Luviquat®, available from BASF), polyacrylonitriles (PAN), styrene-acrylonitriles (SAN), thermoplastic polyurethanes (e.g., Elastollan® 1195 A 10, available from BASF), polysulfone-poly(akylene oxide) copolymers, benzophenone-modified polysulfone (PSU) polymers, polyvinylpyrrolidone-polyvinylactetate copolymers (e.g., Luviskol®, available from BASF), and combinations thereof.

In some embodiments, a support layer includes a polymer that is conductive to certain ions (e.g., alkali metal ions) but is also substantially electrically conductive. Examples of such materials include electrically conductive polymers (also known as electronic polymers or conductive polymers) that are doped with lithium salts (e.g., LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂). Examples of conductive polymers include, but are not limited to, poly(acetylene)s, poly(pyrrole)s, poly(thiophene)s, poly(aniline)s, poly(fluorene)s, polynaphthalenes, poly(p-phenylene sulfide), and poly(para-phenylene vinylene)s. Electrically-conductive additives may also be added to polymers to form electrically-conductive polymers.

In some embodiments, a support layer includes a polymer that is conductive to one or more types of ions. In some cases, the support layer may be substantially non-electrically conductive. Examples of ion-conductive species (that may be substantially non-electrically conductive) include non-electrically conductive materials (e.g., electrically insulating materials) that are doped with lithium salts. E.g., acrylate, polyethyleneoxide, silicones, polyvinylchlorides, and other insulating polymers that are doped with lithium salts can be ion-conductive (but substantially non-electrically conductive). Additional examples of polymers include ionically conductive polymers, sulfonated polymers, and hydrocarbon polymers. Suitable ionically conductive polymers may include, e.g., ionically conductive polymers known to be useful in solid polymer electrolytes and gel polymer electrolytes for lithium electrochemical cells, such as, for example, polyethylene oxides. Suitable sulfonated polymers may include, e.g., sulfonated siloxane polymers, sulfonated polystyrene-ethylene-butylene polymers, and sulfonated polystyrene polymers. Suitable hydrocarbon polymers may include, e.g., ethylene-propylene polymers, polystyrene polymers, and the like.

In some embodiments, a support layer includes a crosslinkable polymer. Non-limiting examples of crosslinkable polymers include: polyvinyl alcohol, polyvinylbutyral, polyvinylpyridyl, polyvinyl pyrrolidone, polyvinyl acetate, acrylonitrile butadiene styrene (ABS), ethylene-propylene rubbers (EPDM), EPR, chlorinated polyethylene (CPE), ethylenebisacrylamide (EBA), acrylates (e.g., alkyl acrylates, glycol acrylates, polyglycol acrylates, ethylene ethyl acrylate (EEA)), hydrogenated nitrile butadiene rubber (HNBR), natural rubber, nitrile butadiene rubber (NBR), certain fluoropolymers, silicone rubber, polyisoprene, ethylene vinyl acetate (EVA), chlorosulfonyl rubber, fluorinated poly(arylene ether) (FPAE), polyether ketones, polysulfones, polyether imides, diepoxides, diisocyanates, diisothiocyanates, formaldehyde resins, amino resins, polyurethanes, unsaturated polyethers, polyglycol vinyl ethers, polyglycol divinyl ethers, copolymers thereof, and those described in U.S. Pat. No. 6,183,901 to Ying et al. of the common assignee for protective coating layers for separator layers.

Additional examples of crosslinkable or crosslinked polymers include UV/E-beam crosslinked Ultrason® or similar polymers (i.e., polymers comprising an amorphous blend of one or more of poly(sulfone), poly(ethersulfone), and poly(phenylsulfone)), UV crosslinked Ultrason®-polyalkyleneoxide copolymers, UV/E-beam crosslinked Ultrason®-acrylamide blends, crosslinked polyisobutylene-polyalkyleneoxide copolymers, crosslinked branched polyimides (BPI), crosslinked maleinimide-Jeffamine polymers (MSI gels), crosslinked acrylamides, and combinations thereof.

Those of ordinary skill in the art can choose appropriate polymers that can be crosslinked, as well as suitable methods of crosslinking, based upon general knowledge of the art in combination with the description herein. Crosslinked polymer materials may further comprise salts, for example, lithium salts, to enhance lithium ion conductivity.

If a crosslinkable polymer is used, the polymer (or polymer precursor) may include one or more crosslinking agents. A crosslinking agent is a molecule with a reactive portion(s) designed to interact with functional groups on the polymer chains in a manner that will form a crosslinking bond between one or more polymer chains. Examples of crosslinking agents that can crosslink polymeric materials used for support layers described herein include, but are not limited to: polyamide-epichlorohydrin (polycup 172); aldehydes (e.g., formaldehyde and urea-formaldehyde); dialdehydes (e.g., glyoxal glutaraldehyde, and hydroxyadipaldehyde); acrylates (e.g., ethylene glycol diacrylate, di(ethylene glycol) diacrylate, tetra(ethylene glycol) diacrylate, methacrylates, ethylene glycol dimethacrylate, di(ethylene glycol) dimethacrylate, tri(ethylene glycol) dimethacrylate); amides (e.g., N,N′-methylenebisacrylamide, N,N′-ethylenebisacrylamide, N,N′-(1,2-dihydroxyethylene)bisacrylamide, N-(1-hydroxy-2,2-dimethoxyethyl)acrylamide); silanes (e.g., methyltrimethoxysilane, methyltriethoxysilane, tetramethoxysilane (TMOS), tetraethoxysilane (TEOS), tetrapropoxysilane, methyltris(methylethyldetoxime)silane, methyltris(acetoxime)silane, methyltris(methylisobutylketoxime)silane, dimethyldi(methylethyldetoxime)silane, trimethyl(methylethylketoxime)silane, vinyltris(methylethylketoxime)silane, methylvinyldi(mtheylethylketoxime)silane, methylvinyldi(cyclohexaneoneoxxime)silane, vinyltris(mtehylisobutylketoxime)silane, methyltriacetoxysilane, tetraacetoxysilane, and phenyltris(methylethylketoxime)silane); divinylbenzene; melamine; zirconium ammonium carbonate; dicyclohexylcarbodiimide/dimethylaminopyridine (DCC/DMAP); 2-chloropyridinium ion; 1-hydroxycyclohexylphenyl ketone; acetophenon dimethylketal; benzoylmethyl ether; aryl triflourovinyl ethers; benzocyclobutenes; phenolic resins (e.g., condensates of phenol with formaldehyde and lower alcohols, such as methanol, ethanol, butanol, and isobutanol), epoxides; melamine resins (e.g., condensates of melamine with formaldehyde and lower alcohols, such as methanol, ethanol, butanol, and isobutanol); polyisocyanates; and dialdehydes.

Other classes of polymers that may be suitable for use in a support layer may include, but are not limited to, polyamines (e.g., poly(ethylene imine) and polypropylene imine (PPI)); polyamides (e.g., poly(e-caprolactam) (Nylon 6), poly(hexamethylene adipamide) (Nylon 66)), polyimides (e.g., polyimide, polynitrile, and poly(pyromellitimide-1,4-diphenyl ether) (Kapton)); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), polychlorotrifluoro ethylene, and poly(isohexylcynaoacrylate)); polyacetals; polyolefins (e.g., poly(butene-1), poly(n-pentene-2), polypropylene, polytetrafluoroethylene); polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride), poly(vinylidene difluoride, poly(vinylidene difluoride block copolymers); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes).

In some embodiments, the molecular weight of a polymer may be chosen to achieve a particular adhesive affinity and can vary in a support layer. In some embodiments, the molecular weight of a polymer used in a support layer may be greater than or equal to 1,000 g/mol, greater than or equal to 5,000 g/mol, greater than or equal to 10,000 g/mol, greater than or equal to 15,000 g/mol, greater than or equal to 20,000 g/mol, greater than or equal to 25,000 g/mol, greater than or equal to 30,000 g/mol, greater than or equal to 50,000 g/mol, greater than or equal to 100,000 g/mol or greater than or equal to 150,000 g/mol. In certain embodiments, the molecular weight of a polymer used in a support layer may be less than or equal to 150,000 g/mol, less than or equal to 100,000 g/mol, less than or equal to 50,000 g/mol, less than or equal to 30,000 g/mol, less than or equal to 25,000 g/mol, less than or equal to 20,000 g/mol, less than less than or equal to 10,000 g/mol, less than or equal to 5,000 g/mol, or less than or equal to 1,000 g/mol. Other ranges are also possible. Combinations of the above-referenced ranges are also possible (e.g., greater than or equal to about 5,000 g/mol and less than or equal to about 50,000 g/mol).

When polymers are used, the polymer may be substantially crosslinked, substantially uncrosslinked, or partially crosslinked as the current disclosure is not limited in this fashion. Further, the polymer may be substantially crystalline, partially crystalline, or substantially amorphous. Without wishing to be bound by theory, embodiments in which the polymer is amorphous may exhibit smoother surfaces since crystallization of the polymer may lead to increased surface roughness. In certain embodiments, the release layer is formed of or includes a wax.

The polymer materials listed above and described herein may further comprise salts, for example, lithium salts (e.g., LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂), to enhance lithium ion conductivity.

As described herein, a support layer may be positioned on a carrier substrate to facilitate fabrication of an electrode. Any suitable material can be used as a carrier substrate. In some embodiments, the material (and thickness) of a carrier substrate may be chosen at least in part due to its ability to withstand certain processing conditions such as high temperature. The substrate material may also be chosen at least in part based on its adhesive affinity to a release layer. In some cases, a carrier substrate is a polymeric material. Examples of suitable materials that can be used to form all or portions of a carrier substrate include certain of those described herein suitable as release layers, optionally with modified molecular weight, crosslinking density, and/or addition of additives or other components. In certain embodiments, a carrier substrate comprises a polyester such as a polyethylene terephthalate (PET) (e.g., optical grade polyethylene terephthalate), polyolefins, polypropylene, nylon, polyvinyl chloride, and polyethylene (which may optionally be metalized). In some cases, a carrier substrate comprises a metal (e.g., a foil such as nickel foil and/or aluminum foil), a glass, or a ceramic material. In some embodiments, a carrier substrate includes a film that may be optionally disposed on a thicker substrate material. For instance, in certain embodiments, a carrier substrate includes one or more films, such as a polymer film (e.g., a PET film) and/or a metalized polymer film (using various metals such as aluminum and copper). A carrier substrate may also include additional components such as fillers, binders, and/or surfactants.

Additionally, a carrier substrate may have any suitable thickness. For instance, the thickness of a carrier substrate may be greater than or equal to about 5 microns, greater than or equal to about 15 microns, greater than or equal to about 25 microns, greater than or equal to about 50 microns, greater than or equal to about 75 microns, greater than or equal to about 100 microns, greater than or equal to about 200 microns, greater than or equal to about 500 microns, or greater than or equal to about 1 mm. In some embodiments, the carrier substrate may have a thickness of less than or equal to about 10 mm, less than or equal to about 5 mm, less than or equal to about 3 mm, or less than or equal to about 1 mm. Combinations of the above-referenced ranges are also possible (e.g., greater than or equal to about 100 microns and less than or equal to about 1 mm.) Other ranges are also possible. In some cases, the carrier substrate has a thickness that is equal to or greater than the thickness of the release layer.

In certain embodiments, the one or more carrier substrates may be left intact with an electrode after fabrication of the electrode, but may be delaminated before the electrode is incorporated into an electrochemical cell. For instance, the electrode may be packaged and shipped to a manufacturer who may then incorporate the electrode into an electrochemical cell. In such embodiments, the electrode may be inserted into an air and/or moisture-tight package to prevent or inhibit deterioration and/or contamination of one or more components of the electrode structure. Allowing the one or more carrier substrates to remain attached to the electrode can facilitate handling and transportation of the electrode. For instance, the carrier substrate(s) may be relatively thick and have a relatively high rigidity or stiffness, which can prevent or inhibit the electrode from distorting during handling. In such embodiments, the carrier substrate(s) can be removed by the manufacturer before, during, or after assembly of an electrochemical cell.

It can be advantageous, according to some embodiments, to apply an anisotropic force to the electrochemical cells described herein during charge and/or discharge. In some embodiments, the electrochemical cells and/or the electrodes described herein can be configured to withstand an applied anisotropic force (e.g., a force applied to enhance the morphology of an electrode within the cell) while maintaining their structural integrity.

In some embodiments, any of the electrodes described herein can be part of an electrochemical cell that is constructed and arranged such that, during at least one period of time during charge and/or discharge of the cell, an anisotropic force with a component normal to the active surface of an electrode within the electrochemical cell (e.g., an electrode comprising lithium metal and/or a lithium alloy, such as an anode comprising lithium metal and/or a lithium alloy) is applied to the cell. In some embodiments, any of the protective layers and/or SEIs described herein can be part of an electrochemical cell that is constructed and arranged such that, during at least one period of time during charge and/or discharge of the cell, an anisotropic force with a component normal to the active surface of an electrode within the electrochemical cell (e.g., an electrode comprising lithium metal and/or a lithium alloy, such as an anode comprising lithium metal and/or a lithium alloy) is applied to the cell. In one set of embodiments, the applied anisotropic force can be selected to enhance the morphology of an electrode (e.g., an electrode comprising lithium metal and/or a lithium alloy, such as a lithium metal and/or a lithium alloy anode).

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes a force applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

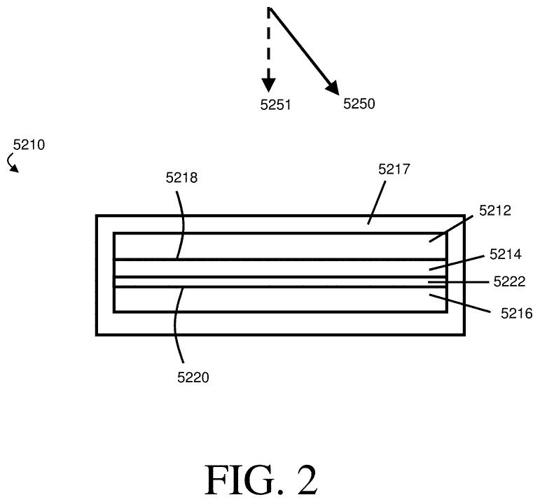

In some such cases, the anisotropic force comprises a component normal to an active surface of an electrode within an electrochemical cell. As used herein, the term “active surface” is used to describe a surface of an electrode at which electrochemical reactions may take place. For example, referring to FIG. 2, an electrochemical cell 5210 can comprise a second electrode 5212 which can include an active surface 5218 and/or a first electrode 5216 which can include an active surface 5220. The electrochemical cell 5210 further comprises an electrolyte 5214 and a protective layer 5222. In some embodiments, an electrochemical cell to which an anisotropic force is applied comprises an SEI (e.g., in addition to, instead of, or as a component of a protective layer). In FIG. 2, a component 5251 of an anisotropic force 5250 is normal to both the active surface of the second electrode and the active surface of the first electrode. In some embodiments, the anisotropic force comprises a component normal to a surface of a protective layer in contact with an electrolyte.

A force with a “component normal” to a surface is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill can understand other examples of these terms, especially as applied within the description of this document. In the case of a curved surface (for example, a concave surface or a convex surface), the component of the anisotropic force that is normal to an active surface of an electrode may correspond to the component normal to a plane that is tangent to the curved surface at the point at which the anisotropic force is applied. The anisotropic force may be applied, in some cases, at one or more pre-determined locations, optionally distributed over the active surface of the electrode and/or over a surface of a protective layer. In some embodiments, the anisotropic force is applied uniformly over the active surface of the first electrode (e.g., of the anode) and/or uniformly over a surface of a protective layer in contact with an electrolyte.

Any of the electrochemical cell properties and/or performance metrics described herein may be achieved, alone or in combination with each other, while an anisotropic force is applied to the electrochemical cell (e.g., during charge and/or discharge of the cell) during charge and/or discharge. In some embodiments, the anisotropic force applied to the electrode and/or to the electrochemical cell (e.g., during at least one period of time during charge and/or discharge of the cell) can include a component normal to an active surface of an electrode (e.g., an anode such as a lithium metal and/or lithium alloy anode within the electrochemical cell). In some embodiments, the component of the anisotropic force that is normal to the active surface of the electrode defines a pressure of greater than or equal to 1 kg/cm², greater than or equal to 2 kg/cm², greater than or equal to 4 kg/cm², greater than or equal to 6 kg/cm², greater than or equal to 8 kg/cm², greater than or equal to 10 kg/cm², greater than or equal to 12 kg/cm², greater than or equal to 14 kg/cm², greater than or equal to 16 kg/cm², greater than or equal to 18 kg/cm², greater than or equal to 20 kg/cm², greater than or equal to 22 kg/cm², greater than or equal to 24 kg/cm², greater than or equal to 26 kg/cm², greater than or equal to 28 kg/cm², greater than or equal to 30 kg/cm², greater than or equal to 32 kg/cm², greater than or equal to 34 kg/cm², greater than or equal to 36 kg/cm², greater than or equal to 38 kg/cm², greater than or equal to 40 kg/cm², greater than or equal to 42 kg/cm², greater than or equal to 44 kg/cm², greater than or equal to 46 kg/cm², or greater than or equal to 48 kg/cm². In some embodiments, the component of the anisotropic force normal to the active surface may, for example, define a pressure of less than or equal to 50 kg/cm², less than or equal to 48 kg/cm², less than or equal to 46 kg/cm², less than or equal to 44 kg/cm², less than or equal to 42 kg/cm², less than or equal to 40 kg/cm², less than or equal to 38 kg/cm², less than or equal to 36 kg/cm², less than or equal to 34 kg/cm², less than or equal to 32 kg/cm², less than or equal to 30 kg/cm², less than or equal to 28 kg/cm², less than or equal to 26 kg/cm², less than or equal to 24 kg/cm², less than or equal to 22 kg/cm², less than or equal to 20 kg/cm², less than or equal to 18 kg/cm², less or equal to 16 kg/cm², less than or equal to 14 kg/cm², less than or equal to 12 kg/cm², less than or equal to 10 kg/cm², less than or equal to 8 kg/cm², less than or equal to 6 kg/cm², less than or equal to 4 kg/cm², or less than or equal to 2 kg/cm². Combinations of the above-referenced ranges are also possible (e.g., greater than or equal to 1 kg/cm² and less than or equal to 50 kg/cm², greater than or equal to 1 kg/cm² and less than or equal to 40 kg/cm², greater than or equal to 1 kg/cm² and less than or equal to 30 kg/cm², greater than or equal to 1 kg/cm² and less than or equal to 20 kg/cm², or greater than or equal to 10 kg/cm² and less than or equal to 20 kg/cm²). Other ranges are also possible.

In some embodiments, the component of the anisotropic force normal to the anode active surface is between about 20% and about 200% of the yield stress of the anode material (e.g., lithium metal), between about 50% and about 120% of the yield stress of the anode material, or between about 80% and about 100% of the yield stress of the anode material.

The anisotropic forces applied during charge and/or discharge as described herein may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

In some embodiments, the articles (e.g., electrochemical cells and/or electrochemical cell components) described herein have one or more advantages (e.g., an increased cycle life, increased capacity, increased stability, reduced oxidation of the electrolyte on an electrode (e.g., the cathode and/or second electrode), increased ability to operate at high voltages, increased ability to be charged to high voltages, increased voltage discharge, increased discharge energy, and/or reduced diffusion of cations of the transition metal (e.g., Co, Ni, Mn) from the second electrode to the electrolyte and/or reduction on the first electrode) compared to an article without one or more (e.g., all) of the reaction products disclosed herein, one or more of the layers (e.g., all) disclosed herein, and/or electrolyte comprising the first reactive species and/or second reactive species, all other factors being equal.

For example, in some embodiments, the article (e.g., electrochemical cell and/or electrochemical cell component) completes (or is configured to complete) greater than or equal to 115%, greater than or equal to 120%, greater than or equal to 140%, greater than or equal to 160%, greater than or equal to 180%, or greater than or equal to 200% the number of charge-discharge cycles before the capacity decreases to 80% of initial capacity compared to an article without one or more (e.g., all) of the reaction products disclosed herein, one or more of the layers (e.g., all) disclosed herein, and/or electrolyte comprising the first reactive species and/or second reactive species, all other factors being equal. In some embodiments, the article completes (or is configured to complete) less than or equal to 500%, less than or equal to 400%, less than or equal to 350%, less than or equal to 300%, less than or equal to 250%, or less than or equal to 200% the number of charge-discharge cycles before the capacity decreases to 80% of initial capacity compared to an article without one or more (e.g., all) of the reaction products disclosed herein, one or more of the layers (e.g., all) disclosed herein, and/or electrolyte comprising the first reactive species and/or second reactive species, all other factors being equal. Combinations of these ranges are also possible (e.g., greater than or equal to 115% and less than or equal to 500% or greater than or equal to 115% and less than or equal to 200%). For example, if the article disclosed herein completes 200 charge-discharge cycles before the capacity decreases to 80% of initial capacity, while an article without one or more (e.g., all) of the reaction products disclosed herein, one or more of the layers (e.g., all) disclosed herein, and/or electrolyte comprising the first reactive species and/or second reactive species (but with all other factors being equal) completes 100 charge-discharge cycles before the capacity decreases to 80% of initial capacity, then the article disclosed herein completed 200% of the charge-discharge cycles of the article without one or more (e.g., all) of the reaction products disclosed herein, one or more of the layers (e.g., all) disclosed herein, and/or electrolyte comprising the first reactive species and/or second reactive species (but with all other factors being equal).

Similarly, in some embodiments, the article (e.g., electrochemical cell and/or electrochemical cell component) completes (or is configured to complete) greater than or equal to 115%, greater than or equal to 125%, greater than or equal to 140%, greater than or equal to 150%, greater than or equal to 175%, greater than or equal to 200%, greater than or equal to 250%, greater than or equal to 300%, greater than or equal to 350%, greater than or equal to 400%, greater than or equal to 450%, greater than or equal to 500%, or greater than or equal to 550% the number of charge-discharge cycles before the capacity decreases to 62.5% of initial capacity compared to an article without one or more (e.g., all) of the reaction products disclosed herein, one or more of the layers (e.g., all) disclosed herein, and/or electrolyte comprising the first reactive species and/or second reactive species, all other factors being equal. In some embodiments, the article completes (or is configured to complete) less than or equal to 1,000%, less than or equal to 900%, less than or equal to 800%, less than or equal to 700%, less than or equal to 600%, or less than or equal to 550% the number of charge-discharge cycles before the capacity decreases to 62.5% of initial capacity compared to an article without one or more (e.g., all) of the reaction products disclosed herein, one or more of the layers (e.g., all) disclosed herein, and/or electrolyte comprising the first reactive species and/or second reactive species, all other factors being equal. Combinations of these ranges are also possible (e.g., greater than or equal to 115% and less than or equal to 1,000%, greater than or equal to 115% and less than or equal to 600%, or greater than or equal to 150% and less than or equal to 550%). For example, if the article disclosed herein completes 500 charge-discharge cycles before the capacity decreases to 62.5% of initial capacity, while an article without one or more (e.g., all) of the reaction products disclosed herein, one or more of the layers (e.g., all) disclosed herein, and/or electrolyte comprising the first reactive species and/or second reactive species (but with all other factors being equal) completes 100 charge-discharge cycles before the capacity decreases to 62.5% of initial capacity, then the article disclosed herein completed 500% of the charge-discharge cycles of the article without one or more (e.g., all) of the reaction products disclosed herein, one or more of the layers (e.g., all) disclosed herein, and/or electrolyte comprising the first reactive species and/or second reactive species (but with all other factors being equal).

In some embodiments, the articles (e.g., electrochemical cells and/or electrochemical cell components) described herein has one or more advantages (e.g., an increased cycle life (as discussed in more detail above), increased capacity, increased stability, reduced oxidation of the electrolyte on an electrode (e.g., the cathode and/or second electrode) compared to an article without one or more (e.g., all) of the reaction products disclosed herein, one or more of the layers (e.g., all) disclosed herein, and/or electrolyte comprising the first reactive species and/or second reactive species, all other factors being equal, when the articles are charged at high voltage. As used herein, a high voltage is a voltage greater than or equal to 4.0 V. For example, in some embodiments, the high voltage is greater than or equal to 4.0 V, greater than or equal to 4.1 V, greater than or equal to 4.2 V, greater than or equal to 4.3 V, greater than or equal to 4.35 V, greater than or equal to 4.5 V, or greater than or equal to 4.6 V. In some embodiments, the high voltage is less than or equal to 4.75 V, less than or equal to 4.7 V, or less than or equal to 4.65 V. Combinations of these ranges are also possible (e.g., greater than or equal to 4.0 V and less than or equal to 4.75 V or greater than or equal to 4.35 V and less than or equal to 4.65 V).

For convenience, some of the terms employed in the specification, examples, and appended claims are listed here. Definitions of specific functional groups and chemical terms are described in more detail below. For purposes of this invention, the chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl,” “alkynyl,” and the like. Furthermore, as used herein, the terms “alkyl,” “alkenyl,” “alkynyl,” and the like encompass both substituted and unsubstituted groups. In some embodiments, as used herein, “aliphatic” is used to indicate those aliphatic groups (cyclic, acyclic, substituted, unsubstituted, branched or unbranched) having 1-20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “alkyl” refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. The alkyl groups may be optionally substituted, as described more fully below. Examples of alkyl groups include, but are not limited to, methyl, ethyl, propyl, isopropyl, butyl, isobutyl, tert-butyl, 2-ethylhexyl, cyclopropyl, cyclobutyl, cyclopentyl, cyclohexyl, and the like. “Heteroalkyl” groups are alkyl groups wherein at least one atom is a heteroatom (e.g., oxygen, sulfur, nitrogen, phosphorus, etc.), with the remainder of the atoms being carbon atoms. Examples of heteroalkyl groups include, but are not limited to, alkoxy, poly(ethylene glycol)-, alkyl-substituted amino, tetrahydrofuranyl, piperidinyl, morpholinyl, etc.

The terms “alkenyl” and “alkynyl” refer to unsaturated aliphatic groups analogous to the alkyl groups described above, but containing at least one double or triple bond respectively.

The term “aryl” refers to an aromatic carbocyclic group having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl), all optionally substituted. “Heteroaryl” groups are aryl groups wherein at least one ring atom in the aromatic ring is a heteroatom, with the remainder of the ring atoms being carbon atoms. Examples of heteroaryl groups include furanyl, thienyl, pyridyl, pyrrolyl, N lower alkyl pyrrolyl, pyridyl N oxide, pyrimidyl, pyrazinyl, imidazolyl, indolyl and the like, all optionally substituted.

The terms “amine” and “amino” refer to both unsubstituted and substituted amines, e.g., a moiety that can be represented by the general formula: N(R′)(R″)(R′″) wherein R′, R″, and R′″ each independently represent a group permitted by the rules of valence.

The term “acyl” is recognized in the art and can include such moieties as can be represented by the general formula:

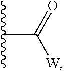

wherein W is H, OH, O-alkyl, O-alkenyl, or a salt thereof. Where W is O-alkyl, the formula represents an “ester.” Where W is OH, the formula represents a “carboxylic acid.” In general, where the oxygen atom of the above formula is replaced by sulfur, the formula represents a “thiocarbonyl” group. Where W is a S-alkyl, the formula represents a “thioester.” On the other hand, where W is alkyl, the above formula represents a “ketone” group. Where W is hydrogen, the above formula represents an “aldehyde” group.

As used herein, the term “heteroaromatic” or “heteroaryl” means a monocyclic or polycyclic heteroaromatic ring (or radical thereof) comprising carbon atom ring members and one or more heteroatom ring members (such as, for example, oxygen, sulfur or nitrogen). Typically, the heteroaromatic ring has from 5 to about 14 ring members in which at least 1 ring member is a heteroatom selected from oxygen, sulfur, and nitrogen. In another embodiment, the heteroaromatic ring is a 5 or 6 membered ring and may contain from 1 to about 4 heteroatoms. In another embodiment, the heteroaromatic ring system has a 7 to 14 ring members and may contain from 1 to about 7 heteroatoms. Representative heteroaryls include pyridyl, furyl, thienyl, pyrrolyl, oxazolyl, imidazolyl, indolizinyl, thiazolyl, isoxazolyl, pyrazolyl, isothiazolyl, pyridazinyl, pyrimidinyl, pyrazinyl, triazinyl, triazolyl, pyridinyl, thiadiazolyl, pyrazinyl, quinolyl, isoquinolyl, indazolyl, benzoxazolyl, benzofuryl, benzothiazolyl, indolizinyl, imidazopyridinyl, isothiazolyl, tetrazolyl, benzimidazolyl, benzoxazolyl, benzothiazolyl, benzothiadiazolyl, benzoxadiazolyl, carbazolyl, indolyl, tetrahydroindolyl, azaindolyl, imidazopyridyl, qunizaolinyl, purinyl, pyrrolo[2,3]pyrimidyl, pyrazolo[3,4]pyrimidyl, benzo(b)thienyl, and the like. These heteroaryl groups may be optionally substituted with one or more substituents.

The term “substituted” is contemplated to include all permissible substituents of organic compounds, “permissible” being in the context of the chemical rules of valence known to those of ordinary skill in the art. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl” must still comprise the phenyl moiety and cannot be modified by substitution, in this definition, to become, e.g., a heteroaryl group such as pyridine. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

Examples of substituents include, but are not limited to, alkyl, aryl, aralkyl, cyclic alkyl, heterocycloalkyl, hydroxy, alkoxy, aryloxy, perhaloalkoxy, aralkoxy, heteroaryl, heteroaryloxy, heteroarylalkyl, heteroaralkoxy, azido, amino, halogen, alkylthio, oxo, acyl, acylalkyl, carboxy esters, carboxyl, carboxamido, nitro, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, alkoxyalkyl, perhaloalkyl, arylalkyloxyalkyl, and the like.

### EXAMPLES

### Example 1 and Comparative Example 1

Example 1 and Comparative Example 1 relate to the fabrication and cycling of an electrochemical cell comprising a triazolate salt (Example 1) and an otherwise equivalent electrochemical cell lacking the triazolate salt, all other factors being equal (Comparative Example 1). The electrochemical cell comprising the triazolate salt had a longer cycle life than the electrochemical cell lacking the triazolate salt.

Each electrochemical cell was prepared by forming a stacked structure in which two anodes, three separators, and three cathodes, where the anodes and separators were each double the length of each cathode, were layered in the following order: anode/separator/cathode/separator/anode/anode/separator/cathode/separator/anode/anode/separat or/cathode/separator/anode, where each cathode was covered on both sides by a double length separator, the first and last cathodes were each covered on both sides by a double length anode, and the middle cathode was covered on each side by the other side of the anode covering the first and last cathodes, respectively. The anodes each had the following structure: 15 micron-thick vapor deposited lithium/200 nm-thick copper current collector/2 micron-thick PVOH release layer, where the vapor deposited lithium was re-laminated to give double-sided anodes, and wherein the anodes had a 100 mm length. The separators were each 9 micron-thick porous polyolefin films manufactured by Tonen. The cathodes each included BASF NCM622 nickel manganese cobalt cathode active material coated at 19.3 mg/cm² on each side of a 16 micron-thick aluminum current collector. The cathode had a total surface area of 100 cm². After formation, the stacked structure was added to a foil pouch, to which 0.55 mL of electrolyte was then also added.

The electrolyte for Example 1 included 1M LiPF₆, 4 wt % LiBOB, and 2 wt % potassium 1H-1,2,4-triazolate dissolved in BASF LP9 (a 80 wt % dimethyl carbonate: 20 wt % fluoroethylene carbonate mixture). The electrolyte for Comparative Example 1 included 1M LiPF₆ and 4 wt % LiBOB dissolved in BASF LP9 (a 80 wt % dimethyl carbonate: 20 wt % fluoroethylene carbonate mixture).

The foil pouch containing the stacked structure and the electrolyte was vacuum sealed, after which it was allowed to sit unrestrained for 24 hours. Then, the electrochemical cells were repeatedly cycled under 10 kg/cm² of pressure according to the following procedure: (1) C/10 (30 mA) charge to 4.5 V; (2) taper at 4.5 V to 3 mA; (3) C/2.5 (120 mA) discharge to 3.2 V. Cycling was stopped when the cells could no longer achieve 80% of their initial capacities.

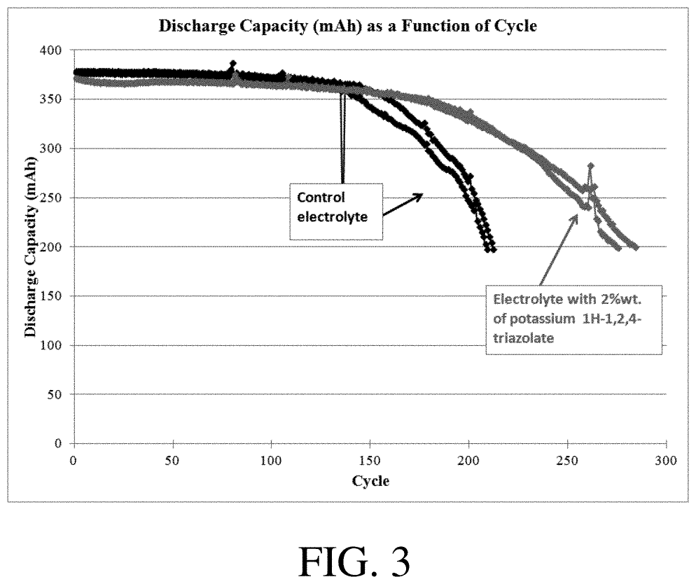

Example 1 had a cycle life of 220 cycles, while Comparative Example 1 had a cycle life of 180 cycles. FIG. 3 shows discharge capacity as a function of time for Example 1 and Comparative Example 1, and shows the comparatively longer cycle life of Example 1.

### Example 2 and Comparative Examples 2-4

Example 2 and Comparative Examples 2-4 relate to the fabrication and cycling of an electrochemical cell comprising a triazolate salt (Example 2) and an otherwise equivalent electrochemical cell lacking the triazolate salt (Comparative Example 2), all other factors being equal. Additional comparative cells lacked the triazolate salt but further included imidazole (Comparative Example 3) or a triazole (Comparative Example 4). The electrochemical cell comprising the triazolate salt (Example 2) had a longer cycle life than the other electrochemical cells.

Each electrochemical cell was prepared by forming a stacked structure in which six, anodes, six separators, and three cathodes were layered in the following order: anode/separator/cathode/separator/anode/anode/separator/cathode/separator/anode/anode/separat or/cathode/separator/anode. The anodes each had the following structure: 16 micron-thick vapor deposited lithium/200 nm-thick copper current collector/2 micron-thick PVOH release layer. The separators were each 9 micron-thick porous polyolefin films manufactured by Tonen. The cathodes each included BASF NCM721 nickel manganese cobalt cathode active material coated at 20.66 mg/cm² on each side of a 16 micron-thick aluminum current collector. The cathode had a total surface area of 100 cm². After formation, the stacked structure was added to a foil pouch, to which 0.55 mL of electrolyte was then also added.

The electrolyte for Example 2 included 1M LiPF₆, 1 wt % LiBOB, and 2 wt % lithium 1H-1,2,4-triazolate dissolved in BASF LP9 (a 80 wt % dimethyl carbonate: 20 wt % fluoroethylene carbonate mixture). The electrolyte for Comparative Example 2 included 1M LiPF₆ and 1 wt % LiBOB dissolved in BASF LP9 (a 80 wt % dimethyl carbonate: 20 wt % fluoroethylene carbonate mixture). The electrolyte for Comparative Example 3 included 1M LiPF₆, 1 wt % LiBOB, and 2 wt % 1H-imidazole dissolved in BASF LP9 (a 80 wt % dimethyl carbonate: 20 wt % fluoroethylene carbonate mixture). The electrolyte for Comparative Example 4 included 1M LiPF₆, 1 wt % LiBOB, and 4 wt % 1H-1,2,4-triazole dissolved in BASF LP9 (a 80 wt % dimethyl carbonate: 20 wt % fluoroethylene carbonate mixture).

The foil pouch containing the stacked structure and the electrolyte was vacuum sealed, after which it was allowed to sit unrestrained for 24 hours. Then, the electrochemical cells were repeatedly cycled under 10 kg/cm² of pressure according to the following procedure: (1) C/4 (75 mA) charge to 4.5 V; (2) taper at 4.5 V to 10 mA; (3) C (300 mA) discharge to 3.2 V. Cycling was stopped when the cells could no longer achieve 80% of their initial capacities.

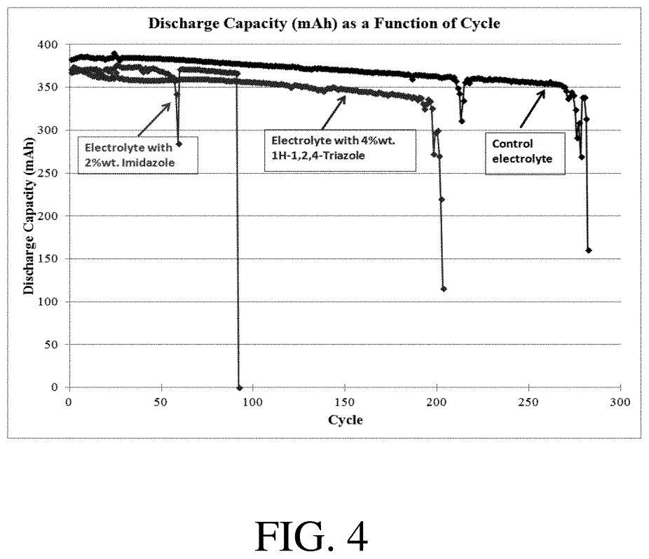

Example 2 had a cycle life of 260 cycles, Comparative Example 2 had a cycle life of 190 cycles, Comparative Example 3 had a cycle life of 92 cycles, and Comparative Example 4 had a cycle life of 197 cycles. FIG. 4 shows discharge capacity as a function of time for Example 2 and Comparative Examples 3 and 4, and shows the comparatively longer cycle life of Example 2.

### Example 3

This Example describes the synthesis of potassium triazolate. A solution of 6.57 g of 1H-1,2,4-triazole dissolved in 150 mL anhydrous tetrahydrofuran was prepared. At room temperature, under argon, and with constant stirring, 3.82 g of potassium hydride was added portionwise to this solution. The resultant reaction mixture was stirred for 1 hour, and then the product was recovered by filtration in an inert atmosphere. After filtration, the product was washed with 20 mL of tetrahydrofuran and then dried under vacuum at 130° C. overnight. 9.4 g of potassium triazolate was recovered at a yield of 92.2%. The potassium triazolate had a melting point of 246-247° C. When analyzed by ¹H NMR in MeOH-d₄ at 400 MHz, the potassium triazolate showed a singlet peak at 7.92 ppm. When analyzed by ¹³C NMR in MeOH-d₄ at 100 MHz, the potassium triazolate showed a peak at 150.37 ppm.

### Example 4

This Example describes the synthesis of lithium triazolate. A solution of 10.78 g of 1H-1,2,4-triazole dissolved in 150 mL anhydrous tetrahydrofuran was prepared. At room temperature, under argon, and with constant stirring, 62.4 mL of a 2.5 M solution of butyl lithium in hexane was added dropwise to this solution. The resultant reaction mixture was stirred for 1 hour, and then the product was recovered by filtration in an inert atmosphere. After filtration, the product was washed with 20 mL of tetrahydrofuran and then dried under vacuum at 130° C. overnight. 9.4 g of lithium triazolate was recovered at a yield of 80.3%. The lithium triazolate had a melting point of 261-262° C. When analyzed by ¹H NMR in MeOH-d₄ at 400 MHz, the lithium triazolate showed a singlet peak at 7.91 ppm. When analyzed by ¹³C NMR in MeOH-d₄ at 100 MHz, the lithium triazolate showed a peak at 150.20 ppm.

### Example 5 and Comparative Example 5

Example 5 and Comparative Examples 5 relate to the fabrication and cycling of electrochemical cells comprising a triazolate salt (Example 5) and otherwise equivalent electrochemical cells lacking the triazolate salt, all other factors being equal (Comparative Example 5). The electrochemical cells comprising the triazolate salt had a longer cycle life than the electrochemical cells lacking the triazolate salt, and the triazolate salt was incorporated into the SEI layers of both electrodes.

Electrochemical cells were assembled having 99.4 cm² electrode active area, a 9 micron polyolefin separator, and 0.55 mL of electrolyte. The negative electrodes/anodes were made of metallic lithium (20 micron vacuum deposited lithium on released Cu/PVOH substrate). The positive electrodes/cathode were NCM811 cathodes. The electrolyte used in Comparative Example 5 was 11.9 wt. % LiPF₆, 16.82 wt. % fluoroethylene carbonate, 67.28 wt. % dimethyl carbonate, and 4 wt. % LiBOB. The electrolyte used in Example 5 was 98 wt. % of the electrolyte used in Comparative Example 5 and 2 wt. % potassium 1H-1,2,4-triazolate (KTZ).

The electrochemical cells were tested under 12 kg/cm² pressure. They were charged at 30 mA to 4.35 V and discharged at 120 mA to 3.2 V. The initial capacity of the cells was 400 mAh. The cells were cycled to a discharge capacity of 250 mAh and the cycle life was determined. Example 5 delivered 472 cycles while Comparative Example 5 delivered 291 cycles. Accordingly, the addition of KTZ provided an improved cycle life, as Example 5 performed 162% the number of cycles as Comparative Example 5.

Example 5′ and Comparative Example 5′—which were identical to Example 5 and Comparative Example 5, respectively—were stopped after the 20^{th} discharge and disassembled. The electrodes were removed, rinsed with dimethyl carbonate, and dried. Their surfaces were analyzed with Energy Dispersive X-ray Spectra (EDS). The EDS results demonstrated that Example 5′ had 2.88% nitrogen on the surface of the anode and 1.47% nitrogen on the surface of the cathode, while no nitrogen was found on the surface of Comparative Example 5′. The only source of nitrogen in the electrolyte was KTZ, demonstrating that KTZ was incorporated into SEI layers on the anode as well as the cathode.

Example 5″ and Comparative Example 5″—which were identical to Example 5 and Comparative Example 5, respectively—were cycled under the same conditions as those used for Example 5 and Comparative Example 5 except that the charge voltage was increased from 4.35 V to 4.55 V. The initial cell capacity was 465 mAh. Example 5″ delivered 281 cycles while Comparative Example 5″ delivered 124 cycles. Accordingly, the addition of KTZ provided an improved cycle life, as Example 5 performed 229% the number of cycles as Comparative Example 5.

### Example 6 and Comparative Example 6

Example 6 and Comparative Examples 6 relate to the fabrication and cycling of electrochemical cells comprising a triazolate salt (Example 6) and otherwise equivalent electrochemical cells lacking the triazolate salt, all other factors being equal (Comparative Example 6). Example 6 was identical to Example 5, and Comparative Example 6 was identical to Comparative Example 5, except that the cathode was an LCO cathode (each contained 2.53 g of LCO material). The electrochemical cells comprising the triazolate salt had a longer cycle life than the electrochemical cells lacking the triazolate salt, and this improvement increased with higher charge voltage.

Example 6 and Comparative Example 6 were charged at 30 mA to voltages from 4.4 V to 4.65 V and discharged at 120 mA to 3.2 V. Table 1 provides the observed performance at various charge voltages. Table 1 demonstrates that the addition of KTZ improved cycle life, and that the degree of improvement increased with higher charge voltage.

TABLE 1
LCO cathode cells performance at various charge voltage

| | | Cathode | | Cathode | | | % of Comparative |
|---|---|---|---|---|---|---|---|
| Charge | Cell Initial | Specific | Average | Specific | Cycle life | | Example 8 |
| Voltage, | Capacity, | Capacity, | Discharge | Energy | Comparative | Cycle life | Cycles Performed |
| V | mAh | mAh/g | Voltage | mWh/g | Example 8 | Example 8 | by Example 8 |
| 4.40 | 418 | 165 | 3.99 | 658 | 261 | 392 | 150% |
| 4.50 | 459 | 181 | 4.03 | 730 | 121 | 255 | 211% |
| 4.55 | 500 | 197 | 4.07 | 800 | 71 | 220 | 310% |
| 4.60 | 548 | 217 | 4.11 | 892 | 16 | 86 | 538% |
| 4.65 | 574 | 225 | 4.06 | 911 | 11 | 61 | 555% |

The following applications are incorporated herein by reference, in their entirety, for all purposes: U.S. Patent Publication No. US 2007/0221265, published on Sep. 27, 2007, filed as application Ser. No. 11/400,781 on Apr. 6, 2006, and entitled “Rechargeable Lithium/Water, Lithium/Air Batteries”; U.S. Patent Publication No. US 2009/0035646, published on Feb. 5, 2009, filed as application Ser. No. 11/888,339 on Jul. 31, 2007, and entitled “Swelling Inhibition in Batteries”; U.S. Patent Publication No. US 2010/0129699, published on May 17, 2010, filed as application Ser. No. 12/312,674 on Feb. 2, 2010, patented as U.S. Pat. No. 8,617,748 on Dec. 31, 2013, and entitled “Separation of Electrolytes”; U.S. Patent Publication No. US 2010/0291442, published on Nov. 18, 2010, filed as application Ser. No. 12/682,011 on Jul. 30, 2010, patented as U.S. Pat. No. 8,871,387 on Oct. 28, 2014, and entitled “Primer for Battery Electrode”; U.S. Patent Publication No. US 2009/0200986, published on Aug. 31, 2009, filed as application Ser. No. 12/069,335 on Feb. 8, 2008, patented as U.S. Pat. No. 8,264,205 on Sep. 11, 2012, and entitled “Circuit for Charge and/or Discharge Protection in an Energy-Storage Device”; U.S. Patent Publication No. US 2007/0224502, published on Sep. 27, 2007, filed as application Ser. No. 11/400,025 on Apr. 6, 2006, patented as U.S. Pat. No. 7,771,870 on Aug. 10, 2010, and entitled “Electrode Protection in Both Aqueous and Non-Aqueous Electrochemical cells, Including Rechargeable Lithium Batteries”; U.S. Patent Publication No. US 2008/0318128, published on Dec. 25, 2008, filed as application Ser. No. 11/821,576 on Jun. 22, 2007, and entitled “Lithium Alloy/Sulfur Batteries”; U.S. Patent Publication No. US 2002/0055040, published on May 9, 2002, filed as application Ser. No. 09/795,915 on Feb. 27, 2001, patented as U.S. Pat. No. 7,939,198 on May 10, 2011, and entitled “Novel Composite Cathodes, Electrochemical Cells Comprising Novel Composite Cathodes, and Processes for Fabricating Same”; U.S. Patent Publication No. US 2006/0238203, published on Oct. 26, 2006, filed as application Ser. No. 11/111,262 on Apr. 20, 2005, patented as U.S. Pat. No. 7,688,075 on Mar. 30, 2010, and entitled “Lithium Sulfur Rechargeable Battery Fuel Gauge Systems and Methods”; U.S. Patent Publication No. US 2008/0187663, published on Aug. 7, 2008, filed as application Ser. No. 11/728,197 on Mar. 23, 2007, patented as U.S. Pat. No. 8,084,102 on Dec. 27, 2011, and entitled “Methods for Co-Flash Evaporation of Polymerizable Monomers and Non-Polymerizable Carrier Solvent/Salt Mixtures/Solutions”; U.S. Patent Publication No. US 2011/0006738, published on Jan. 13, 2011, filed as application Ser. No. 12/679,371 on Sep. 23, 2010, and entitled “Electrolyte Additives for Lithium Batteries and Related Methods”; U.S. Patent Publication No. US 2011/0008531, published on Jan. 13, 2011, filed as application Ser. No. 12/811,576 on Sep. 23, 2010, patented as U.S. Pat. No. 9,034,421 on May 19, 2015, and entitled “Methods of Forming Electrodes Comprising Sulfur and Porous Material Comprising Carbon”; U.S. Patent Publication No. US 2010/0035128, published on Feb. 11, 2010, filed as application Ser. No. 12/535,328 on Aug. 4, 2009, patented as U.S. Pat. No. 9,105,938 on Aug. 11, 2015, and entitled “Application of Force in Electrochemical Cells”; U.S. Patent Publication No. US 2011/0165471, published on Jul. 15, 2011, filed as application Ser. No. 12/180,379 on Jul. 25, 2008, and entitled “Protection of Anodes for Electrochemical Cells”; U.S. Patent Publication No. US 2006/0222954, published on Oct. 5, 2006, filed as application Ser. No. 11/452,445 on Jun. 13, 2006, patented as U.S. Pat. No. 8,415,054 on Apr. 9, 2013, and entitled “Lithium Anodes for Electrochemical Cells”; U.S. Patent Publication No. US 2010/0239914, published on Sep. 23, 2010, filed as application Ser. No. 12/727,862 on Mar. 19, 2010, and entitled “Cathode for Lithium Battery”; U.S. Patent Publication No. US 2010/0294049, published on Nov. 25, 2010, filed as application Ser. No. 12/471,095 on May 22, 2009, patented as U.S. Pat. No. 8,087,309 on Jan. 3, 2012, and entitled “Hermetic Sample Holder and Method for Performing Microanalysis under Controlled Atmosphere Environment”; U.S. Patent Publication No. US 2011/00765560, published on Mar. 31, 2011, filed as application Ser. No. 12/862,581 on Aug. 24, 2010, and entitled “Electrochemical Cells Comprising Porous Structures Comprising Sulfur”; U.S. Patent Publication No. US 2011/0068001, published on Mar. 24, 2011, filed as application Ser. No. 12/862,513 on Aug. 24, 2010, and entitled “Release System for Electrochemical Cells”; U.S. Patent Publication No. US 2012/0048729, published on Mar. 1, 2012, filed as application Ser. No. 13/216,559 on Aug. 24, 2011, and entitled “Electrically Non-Conductive Materials for Electrochemical Cells”; U.S. Patent Publication No. US 2011/0177398, published on Jul. 21, 2011, filed as application Ser. No. 12/862,528 on Aug. 24, 2010, and entitled “Electrochemical Cell”; U.S. Patent Publication No. US 2011/0070494, published on Mar. 24, 2011, filed as application Ser. No. 12/862,563 on Aug. 24, 2010, and entitled “Electrochemical Cells Comprising Porous Structures Comprising Sulfur”; U.S. Patent Publication No. US 2011/0070491, published on Mar. 24, 2011, filed as application Ser. No. 12/862,551 on Aug. 24, 2010, and entitled “Electrochemical Cells Comprising Porous Structures Comprising Sulfur”; U.S. Patent Publication No. US 2011/0059361, published on Mar. 10, 2011, filed as application Ser. No. 12/862,576 on Aug. 24, 2010, patented as U.S. Pat. No. 9,005,009 on Apr. 14, 2015, and entitled “Electrochemical Cells Comprising Porous Structures Comprising Sulfur”; U.S. Patent Publication No. US 2012/0070746, published on Mar. 22, 2012, filed as application Ser. No. 13/240,113 on Sep. 22, 2011, and entitled “Low Electrolyte Electrochemical Cells”; U.S. Patent Publication No. US 2011/0206992, published on Aug. 25, 2011, filed as application Ser. No. 13/033,419 on Feb. 23, 2011, and entitled “Porous Structures for Energy Storage Devices”; U.S. Patent Publication No. 2013/0017441, published on Jan. 17, 2013, filed as application Ser. No. 13/524,662 on Jun. 15, 2012, patented as U.S. Pat. No. 9,548,492 on Jan. 17, 2017, and entitled “Plating Technique for Electrode”; U.S. Patent Publication No. US 2013/0224601, published on Aug. 29, 2013, filed as application Ser. No. 13/766,862 on Feb. 14, 2013, patented as U.S. Pat. No. 9,077,041 on Jul. 7, 2015, and entitled “Electrode Structure for Electrochemical Cell”; U.S. Patent Publication No. US 2013/0252103, published on Sep. 26, 2013, filed as application Ser. No. 13/789,783 on Mar. 8, 2013, patented as U.S. Pat. No. 9,214,678 on Dec. 15, 2015, and entitled “Porous Support Structures, Electrodes Containing Same, and Associated Methods”; U.S. Patent Publication No. US 2013/0095380, published on Apr. 18, 2013, filed as application Ser. No. 13/644,933 on Oct. 4, 2012, patented as U.S. Pat. No. 8,936,870 on Jan. 20, 2015, and entitled “Electrode Structure and Method for Making the Same”; U.S. Patent Publication No. US 2014/0123477, published on May 8, 2014, filed as application Ser. No. 14/069,698 on Nov. 1, 2013, patented as U.S. Pat. No. 9,005,311 on Apr. 14, 2015, and entitled “Electrode Active Surface Pretreatment”; U.S. Patent Publication No. US 2014/0193723, published on Jul. 10, 2014, filed as application Ser. No. 14/150,156 on Jan. 8, 2014, patented as U.S. Pat. No. 9,559,348 on Jan. 31, 2017, and entitled “Conductivity Control in Electrochemical Cells”; U.S. Patent Publication No. US 2014/0255780, published on Sep. 11, 2014, filed as application Ser. No. 14/197,782 on Mar. 5, 2014, patented as U.S. Pat. No. 9,490,478 on Nov. 6, 2016, and entitled “Electrochemical Cells Comprising Fibril Materials”; U.S. Patent Publication No. US 2014/0272594, published on Sep. 18, 2014, filed as application Ser. No. 13/833,377 on Mar. 15, 2013, and entitled “Protective Structures for Electrodes”; U.S. Patent Publication No. US 2014/0272597, published on Sep. 18, 2014, filed as application Ser. No. 14/209,274 on Mar. 13, 2014, and entitled “Protected Electrode Structures and Methods”; U.S. Patent Publication No. US 2014/0193713, published on Jul. 10, 2014, filed as application Ser. No. 14/150,196 on Jan. 8, 2014, patented as U.S. Pat. No. 9,531,009 on Dec. 27, 2016, and entitled “Passivation of Electrodes in Electrochemical Cells”; U.S. Patent Publication No. US 2014/0272565, published on Sep. 18, 2014, filed as application Ser. No. 14/209,396 on Mar. 13, 2014, and entitled “Protected Electrode Structures”; U.S. Patent Publication No. US 2015/0010804, published on Jan. 8, 2015, filed as application Ser. No. 14/323,269 on Jul. 3, 2014, and entitled “Ceramic/Polymer Matrix for Electrode Protection in Electrochemical Cells, Including Rechargeable Lithium Batteries”; U.S. Patent Publication No. US 2015/044517, published on Feb. 12, 2015, filed as application Ser. No. 14/455,230 on Aug. 8, 2014, and entitled “Self-Healing Electrode Protection in Electrochemical Cells”; U.S. Patent Publication No. US 2015/0236322, published on Aug. 20, 2015, filed as application Ser. No. 14/184,037 on Feb. 19, 2014, and entitled “Electrode Protection Using Electrolyte-Inhibiting Ion Conductor”; U.S. Patent Publication No. US 2016/0072132, published on Mar. 10, 2016, filed as application Ser. No. 14/848,659 on Sep. 9, 2015, and entitled “Protective Layers in Lithium-Ion Electrochemical Cells and Associated Electrodes and Methods”; U.S. patent application Ser. No. 16/670,933, filed Oct. 31, 2019, entitled “System And Method For Operating A Rechargeable Electrochemical Cell Or Battery”; U.S. patent application Ser. No. 16/527,903, filed Jul. 31, 2019, published as U.S. Pub. No. US2020-0044460, and entitled “Multiplexed Charge Discharge Battery Management System”; U.S. patent application Ser. No. 16/670,905, filed Oct. 31, 2019, entitled “System And Method For Operating A Rechargeable Electrochemical Cell Or Battery”; and International Patent Apl. Serial No. PCT/US2019/059142, filed Oct. 31, 2019, entitled “System And Method For Operating A Rechargeable Electrochemical Cell Or Battery”. All other patents and patent applications disclosed herein are also incorporated by reference in their entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1-2. (canceled)

3. An electrochemical cell, comprising:
a first electrode comprising lithium metal; and
a protective layer disposed on the first electrode, wherein the protective layer comprises a species comprising a conjugated, negatively-charged ring comprising a nitrogen atom and/or a reaction product thereof, and wherein an electron-withdrawing substituent is absent from the species.

4. The electrochemical cell of claim 3, further comprising an electrolyte.

5. The electrochemical cell of claim 4, wherein the electrolyte comprises the species.

6. The electrochemical cell of claim 3, wherein the protective layer comprises the species.

7. The electrochemical cell of claim 3, wherein the protective layer comprises the reaction product.

8. The electrochemical cell of claim 3, wherein the reaction product comprises a reaction product between lithium metal and the species.

9. The electrochemical cell of claim 3, further comprising a second electrode.

10. The electrochemical cell of claim 9, wherein the second electrode comprises a transition metal.

11. The electrochemical cell of claim 10, wherein a second protective layer is disposed on the second electrode.

12. The electrochemical cell of claim 11, wherein the second protective layer comprises the species and/or a second reaction product thereof.

13. The electrochemical cell of claim 12, wherein the second protective layer comprises the species.

14. The electrochemical cell of claim 12, wherein the second protective layer comprises the second reaction product.

15. The electrochemical cell of claim 12, wherein the second reaction product comprises a reaction product between the transition metal and the species.

16-21. (canceled)

22. A method, comprising:
placing a volume of an electrolyte in an electrochemical cell comprising a first electrode,
wherein the first electrode comprises lithium metal, and
wherein the electrolyte comprises a species comprising a conjugated, negatively-charged ring comprising a nitrogen atom; and
forming a protective layer on the first electrode, wherein the protective layer comprises the species and/or a reaction product thereof; and
wherein an electron-withdrawing substituent is absent from the species.

23-126. (canceled)

127. The electrochemical cell of claim 3, wherein the conjugated, negatively-charged ring comprising the nitrogen atom has the structure: 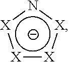
wherein:
each instance of X is independently selected from the group consisting of —N═ and —CR=;
each instance of R is independently selected from hydrogen, optionally substituted alkyl, alkoxy, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide; and
optionally, wherein any two instances of R are joined to form a ring.

128-136. (canceled)

137. The electrochemical cell of claim 127, wherein 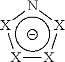
comprises: 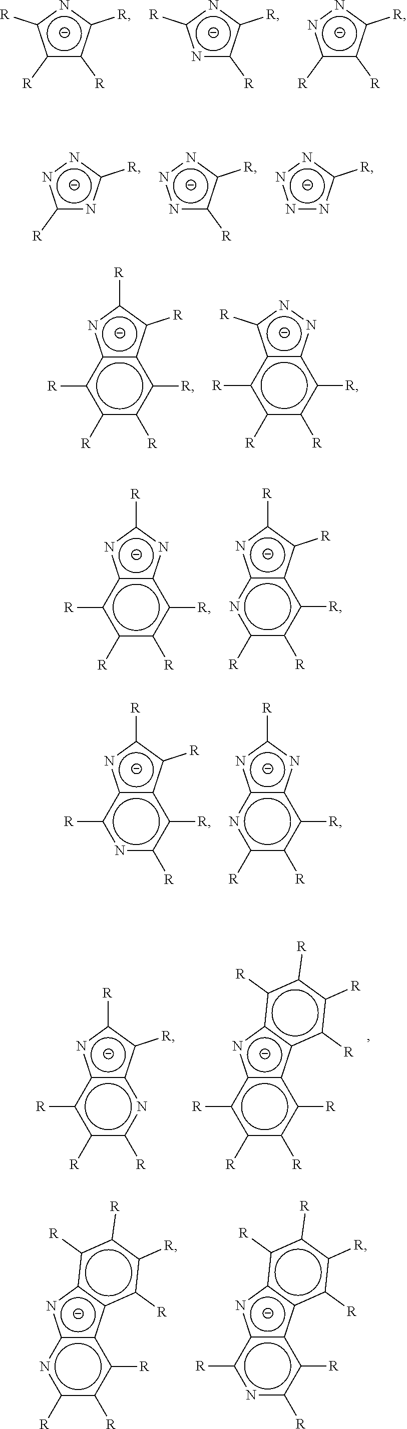 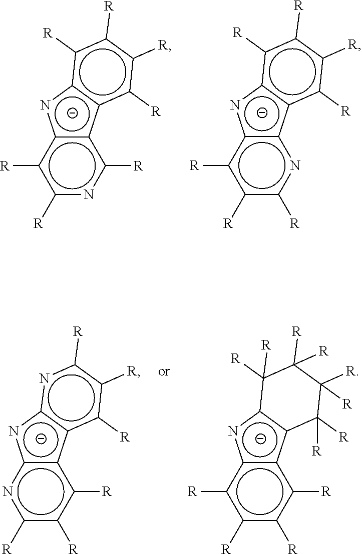
wherein:
each instance of R is independently selected from hydrogen, optionally substituted alkyl, alkoxy, optionally substituted heteroalkyl, optionally substituted cycloheteroalkyl, optionally substituted alkenyl, optionally substituted alkynyl, optionally substituted aryl, optionally substituted heteroaryl, optionally substituted alkenyloxy, optionally substituted alkoxy, optionally substituted thio, epoxy, optionally substituted oxyacyloxy, optionally substituted aminoacyl, azide, optionally substituted amino, optionally substituted phosphine, or optionally substituted sulfide; and
optionally, wherein any two instances of R are joined to form a ring.

138-139. (canceled)

140. The electrochemical cell of claim 3, wherein the protective layer further comprises a plurality of particles.

141-144. (canceled)

145. An electrochemical cell, comprising:
a first electrode comprising lithium metal; and
an electrolyte, wherein the electrolyte comprises a species comprising a conjugated, negatively-charged ring comprising a nitrogen atom, and wherein an electron-withdrawing substituent is absent from the species.

146. The electrochemical cell of claim 16, wherein the second species comprises PF₆⁺, fluoroethylene carbonate, difluoroethylene carbonate, a difluoro(oxalato)borate anion, a bis(fluorosulfonyl)imide anion, a bis(trifluoromethane sulfonyl)imide anion, chloroethylene carbonate, substituted or unsubstituted 1,2,4-triazole, 1,2,3-triazole, 1,3,4-triazole, pyrazole, imidazole, tetrazole, benzimidazole, indazole, and/or benzotriazole.

147. The electrochemical cell of claim 3, wherein the conjugated, negatively-charged ring comprising the nitrogen atom is a pyrrolate derivative, an azolate derivative, an imidazolate derivative, a pyrazolate derivative, and/or a triazolate derivative.
